(19) United States
(12) Patent Application Publication
(10) Pub. No.: US 2026/0050519 A1
(43) Pub. Date: Feb. 19, 2026

(54) ERROR CORRECTION CODE CIRCUIT, MEMORY DEVICE AND MEMORY SYSTEM INCLUDING SAME

(71) Applicant: SAMSUNG ELECTRONICS CO., LTD., SUWON-SI (KR)

(72) Inventors: DONGGEUN LEE, Suwon-si (KR); YUJUNG SONG, Suwon-si (KR); SUNG-RAE KIM, Suwon-si (KR)

(21) Appl. No.: 19/066,589

(22) Filed: Feb. 28, 2025

(30) Foreign Application Priority Data
Aug. 14, 2024 (KR) 10-2024-0109401

(51) Int. Cl. G06F 11/10

(52) U.S. Cl. CPC G06F 11/1096

(57) ABSTRACT

Disclosed is a memory device which includes an input/output circuit receiving first data and first parity data from a memory controller, an ECC encoder generating parity check data based on the first data, a syndrome generator generating a syndrome based on the parity check data and the first parity data, an error vector generator performing ECC decoding based on the syndrome and generating an error vector, an error correction circuit generating error-corrected data based on the error vector, the first data, and the first parity data, and a memory cell array storing the error-corrected data. The error vector generator includes an arithmetic circuit performing a common operation associated with the ECC decoding based on the syndrome and generating a common arithmetic signal, and a plurality of comparison circuits generating the error vector based on the syndrome and the common arithmetic signal.

### CROSS-REFERENCE TO RELATED APPLICATION(S)

This application is related to and claims priority under 35 U.S.C. § 119 to Korean Patent Application No. 10-2024-0109401 filed on Aug. 14, 2024, in the Korean Intellectual Property Office, the disclosure of which is incorporated by reference herein in its entirety.

### TECHNICAL FIELD

Embodiments of the present disclosure described herein relate to a semiconductor memory, and more particularly, to error correction coding in a memory device.

### DISCUSSION OF RELATED ART

A semiconductor memory may be classified as a volatile memory, which loses data stored therein when a power is turned off, or a nonvolatile memory, which retains data stored therein even when power is turned off. Examples of a volatile memory include static random access memory (SRAM) and dynamic random access memory (DRAM). Examples of a nonvolatile memory include flash memory, phase-change RAM (PRAM), magnetic RAM (MRAM), resistive RAM (RRAM), and a ferroelectric RAM (FRAM).

DRAM is widely used as a system memory of a mobile device or a computer device. Nowadays, a DRAM device includes an error correction code (ECC) circuit for improving the reliability of data stored therein. The ECC circuit may correct errors of data stored in the DRAM device. With ongoing advances in technology, the memory capacity of DRAM devices is increasing, and the implementation of the ECC circuit occupying a smaller area has become desirable.

### SUMMARY

Embodiments of the present disclosure provide an error correction code circuit that occupies a smaller area through reduction of logic circuitry, a memory device including the error correction code circuit, and a memory system including the memory device.

According to an embodiment, a memory device includes an input/output circuit that receives first data and first parity data from a memory controller, an error correction code (ECC) encoder that generates parity check data based on the first data, a syndrome generator that generates a syndrome based on the parity check data and the first parity data, an error vector generator that performs ECC decoding based on the syndrome and to generate an error vector, an error correction circuit that generates error-corrected data based on the error vector, the first data, and the first parity data, and a memory cell array that stores the error-corrected data. The error vector generator includes an arithmetic circuit that performs a common operation associated with the ECC decoding based on the syndrome and generates a common arithmetic signal, and a plurality of comparison circuits that generates the error vector based on the syndrome and the common arithmetic signal.

According to an embodiment, an error correction code (ECC) circuit which generates error-corrected data based on first data and first parity data received from a memory controller includes an ECC encoder that generates parity check data based on the first data, and an ECC decoder that performs ECC decoding based on the first data, the first parity data, and the parity check data and outputs the error-corrected data. The ECC decoder includes a syndrome generator that generates a syndrome based on the parity check data and the first parity data, an error vector generator that decodes the syndrome to generate an error vector, and an error correction circuit that generates the error-corrected data based on the error vector, the first data, and the first parity data. The error vector generator includes an arithmetic circuit that performs a common operation associated with the ECC decoding based on the syndrome and generates a common arithmetic signal, and a plurality of comparison circuits that generate the error vector based on the syndrome and the common arithmetic signal.

According to an embodiment, a memory system includes a memory controller that outputs first data and first parity data generated based on the first data, and a memory device that includes an error correction code (ECC) circuit receiving the first data and the first parity data and generating error-corrected data based on the first data and the first parity data and stores the error-corrected data. The ECC circuit includes an ECC encoder that generates parity check data based on the first data, a syndrome generator circuit that generates a syndrome based on the parity check data and the first parity data, an error vector generator circuit that generates an error vector by ECC decoding the syndrome, and an error correction circuit that generates the error-corrected data based on the error vector, the first data, and the first parity data. The error vector generator includes an arithmetic circuit that performs a common operation associated with the ECC decoding based on the syndrome and generates a common arithmetic signal, and a plurality of comparison circuits that generate the error vector based on the syndrome and the common arithmetic signal.

### BRIEF DESCRIPTION OF THE FIGURES

The above and other aspects and features of the present disclosure will become apparent by describing in detail embodiments thereof with reference to the accompanying drawings.

FIG. 1 is a block diagram illustrating a memory system according to an embodiment of the present disclosure.

FIG. 2 is a block diagram illustrating a memory device of FIG. 1.

FIG. 3 is a block diagram for describing an operation of a memory ECC circuit of FIG. 2.

FIG. 4 is a flowchart illustrating an operation of an ECC circuit of FIG. 3.

FIG. 5 is a diagram illustrating an example of a portion of an H-matrix used by a memory ECC circuit of FIG. 3.

FIG. 6 is a diagram for describing an ECC encoding operation.

FIG. 7 is a block diagram for describing an ECC encoder of FIG. 3.

FIG. 8 is a logic gate diagram for describing an example of a 0-th encoding circuit of FIG. 7 according to a comparative example.

FIG. 9 is a diagram for describing a 0-th encoding circuit of FIG. 7.

FIG. 10 is a functional block diagram of an ECC decoder of FIG. 3 according to an example.

FIG. 11 is a functional block diagram of an error vector generator of FIG. 10 according to an example.

FIG. 12A is a diagram for describing an example of a 0-th ECC decoding circuit of FIG. 11.

FIG. 12B is a diagram for describing a syndrome comparison signal of FIG. 11.

FIG. 13 illustrates a 0-th sub-matrix of FIG. 5.

FIG. 14 is a block diagram for describing a 0-th ECC decoding circuit of FIG. 11.

FIGS. 15A, 15B and 15C are diagrams for describing a common arithmetic circuit of FIG. 14.

FIG. 16A is a diagram for describing a first syndrome comparison circuit of FIG. 14.

FIG. 16B is a diagram for describing a second syndrome comparison circuit of FIG. 14.

FIG. 17 is a block diagram illustrating a memory system according to an embodiment of the present disclosure.

### DETAILED DESCRIPTION

Below, embodiments of the present disclosure will be described in detail and clearly to such an extent that one skilled in the art easily carries out the present disclosure.

In this detailed description, function blocks of drawings, which respectively correspond to the terms “block”, “unit”, “logic”, etc., may be implemented in the form of software executed by a processor, hardware circuitry, or a combination thereof.

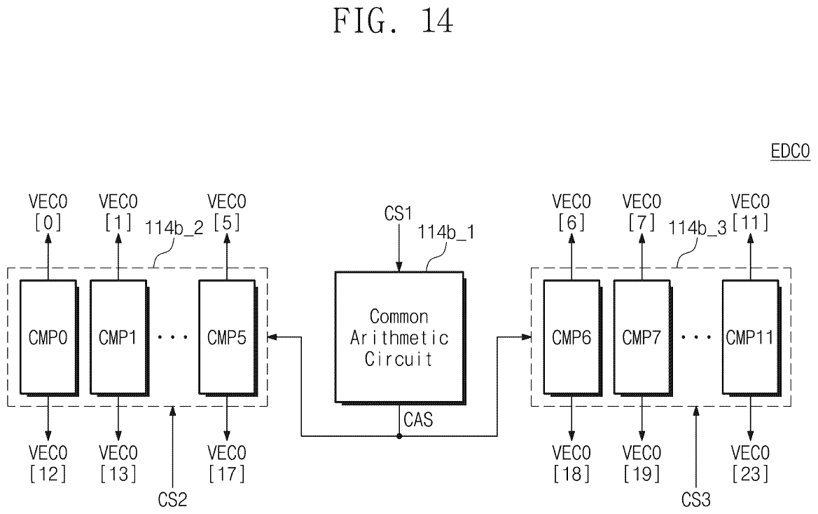

Embodiments of the present inventive concept such as those described below provide a memory device and system and an ECC circuit employing “syndrome decoding” with reduced circuit complexity. Circuit complexity may be reduced by providing an ECC encoder and an ECC decoder implemented in consideration of a structure (e.g., symmetric and common characteristics) of a parity-check matrix (“H-matrix”), so that unnecessary arithmetic circuits can be eliminated. By reducing circuit complexity, the area occupied by the ECC circuit may be beneficially reduced, and power consumption may also be reduced. The reduction in circuitry may be realized by in part through the provision of a “common arithmetic circuit” (e.g., 114b_1 of FIG. 14) that performs a common operation associated with ECC decoding based on a syndrome, and which generates a common arithmetic signal (e.g., CAS of FIG. 14). A plurality of comparison circuits (e.g., CMP0-CMP11) may be configured to generate an error vector in the syndrome decoding based on the syndrome and the common arithmetic signal.

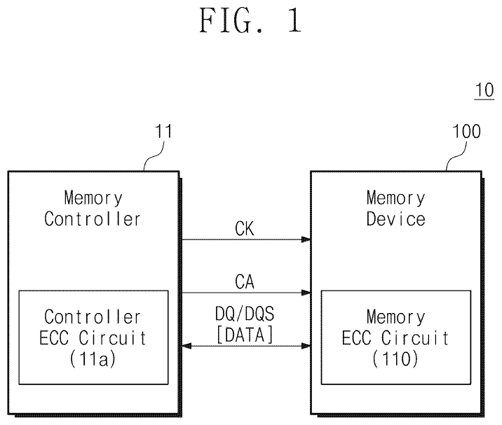

FIG. 1 is a block diagram illustrating a memory system according to an embodiment of the present disclosure. Referring to FIG. 1, a memory system 10 may include a memory controller 11 and a memory device 100. In an embodiment, the memory system 10 may be part of an information processing device configured to process a variety of information and to store the processed information, such as a personal computer (PC), a laptop, a server, a workstation, a smartphone, a tablet PC, a digital camera, and a black box.

The memory controller 11 may store the data in the memory device 100 or may read the data stored in the memory device 100. For example, the memory controller 11 may send a clock signal CK and a command/address signal CA to the memory device 100 and may exchange a data signal DQ and a data strobe signal DQS with the memory device 100. In an embodiment, through the data signal DQ and the data strobe signal DQS, data “DATA” may be transmitted from the memory controller 11 to the memory device 100 or may be transmitted from the memory device 100 to the memory controller 11. In an embodiment, the memory controller 11 and the memory device 100 may communicate with each other based on the DDR interface or the LPDDR interface, but the present disclosure is not limited thereto.

In an embodiment, the memory controller 11 may include a controller error correction code (ECC) circuit 11a. The controller ECC circuit 11a may be configured to generate parity data by performing ECC encoding on corresponding first data transmitted from an external host (not illustrated). The memory controller 11 may transmit the data “DATA” including the first data and the parity data to the memory device 100 together with a write command. Also, the controller ECC circuit 11a may be configured to detect and correct an error of second data received from the memory device 100 as a response to a read command. For example, while the second data are transmitted from the memory device 100 to the memory controller 11, an error may occur in the second data due to various factors.

The controller ECC circuit 11a may perform ECC decoding based on the second data and may correct the error of the second data.

The memory device 100 may receive the first data and the parity data from the memory controller 11. In an embodiment, the memory device 100 may include a memory ECC circuit 110. The memory ECC circuit 110 may be configured to detect and correct an error of the first data and the parity data. For example, while the first data and the parity data are transmitted from the memory controller 11 to the memory device 100, an error may occur in the first data or the parity data due to various factors. The memory ECC circuit 110 may perform ECC decoding based on the first data and the parity data and may correct the error of the first data or the parity data. The memory device 100 may store the corrected data. Meanwhile, when the read command for third data stored in the memory device 100 is generated by the memory controller 11, the memory ECC circuit 110 may be configured to generate third parity data by performing ECC encoding on the third data. The memory device 100 may transmit the data “DATA” including the third data and the third parity data to the memory controller 11 in response to the read command.

In other words, the controller ECC circuit 11a may correct an error which occurs in the process of transmitting the data “DATA” from the memory device 100 to the memory controller 11. The memory ECC circuit 110 may correct an error which occurs in the process of transmitting the data “DATA” from the memory controller 11 to the memory device 100.

Meanwhile, the controller ECC circuit 11a and the memory ECC circuit 110 may perform ECC encoding and ECC decoding which are based on a parity-check matrix (hereinafter referred to as an “H-matrix”). In an embodiment, the controller ECC circuit 11a and the memory ECC circuit 110 may be configured to perform operations for ECC encoding and ECC decoding based on a structure of the H-matrix. This allows the controller ECC circuit 11a and the memory ECC circuit 110 to be configured without a plurality of identical arithmetic circuits for performing the same operation. Accordingly, the area which the controller ECC circuit 11a and the memory ECC circuit 110 occupy in the memory system 10 may be minimized. As a result, an ECC circuit of a smaller size and complexity, a memory device including the ECC circuit, and a memory system including the memory device may be provided.

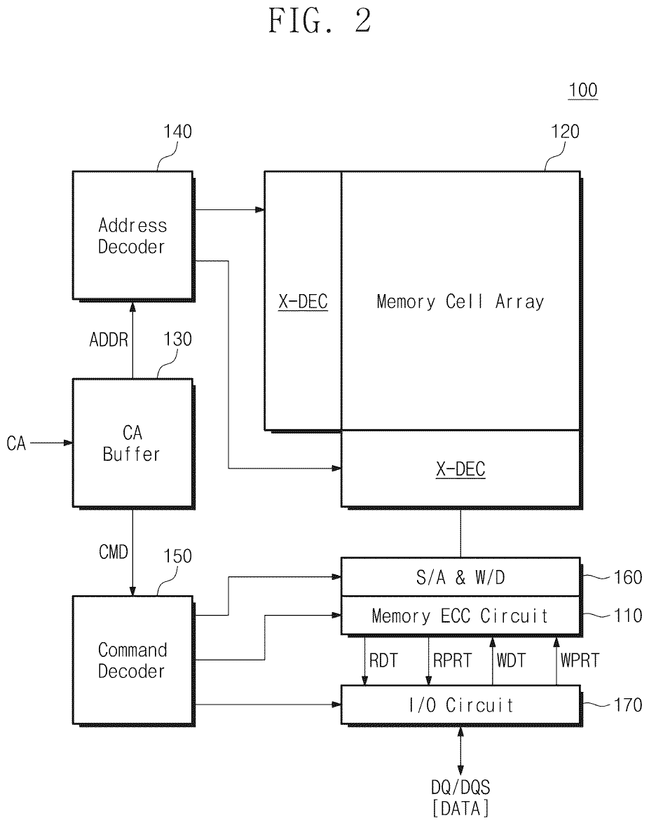

FIG. 2 is a block diagram illustrating a memory device of FIG. 1. Referring to FIGS. 1 and 2, the memory device 100 may include the memory ECC circuit 110, a memory cell array 120, a CA buffer 130, an address decoder 140, a command decoder 150, a sense amplifier and write driver 160, and an input/output circuit 170.

The memory ECC circuit 110 may generate read parity data RPRT by performing ECC encoding on read data RDT stored in the memory cell array 120. Alternatively or additionally, the memory ECC circuit 110 may correct an error of write data WDT or write parity data WPRT received from the memory controller 11 through the input/output circuit 170 by performing ECC decoding based on the write data WDT and the write parity data WPRT. A configuration and an operation of the memory ECC circuit 110 will be described in detail with reference to the following drawings.

The memory cell array 120 may include a plurality of memory cells. The plurality of memory cells may be connected to a plurality of word lines and a plurality of bit lines. In an embodiment, the plurality of word lines may be driven by an X-decoder (or row decoder) (X-DEC), and the plurality of bit lines may be driven by a Y-decoder (or column decoder) (Y-DEC).

The CA buffer 130 may be configured to receive the command/address signals CA and to temporarily store or buffer the received signals.

The address decoder 140 may decode address signals ADDR stored in the CA buffer 130. The address decoder 140 may control the X-decoder and the Y-decoder based on the decoding result.

The command decoder 150 may decode a command CMD stored in the CA buffer 130. The command decoder 150 may control the components of the memory device 100 based on a decoding result. For example, when the command signal stored in the CA buffer 130 corresponds to the write command (i.e., when a command received from the memory controller 11 is the write command), the command decoder 150 may control the memory ECC circuit 110 such that the data “DATA” received through the input/output circuit 170 are written in the memory cell array 120 (e.g., after ECC decoding is performed) and may control an operation of the sense amplifier and write driver 160 (i.e., may activate the write driver).

Alternatively, when the command signal stored in the CA buffer 130 corresponds to a read command (i.e., when the command received from the memory controller 11 is the read command), the command decoder 150 may control the sense amplifier and write driver 160 (i.e., may activate the sense amplifier) such that data stored in the memory cell array 120 are read out and may control the memory ECC circuit 110 (and may perform ECC encoding).

Under control of the command decoder 150, the sense amplifier and write driver 160 may read data stored in the memory cell array 120 through the plurality of bit lines or may write data in the memory cell array 120 through the plurality of bit lines.

Based on the data signal DQ and the data strobe signal DQS, the input/output circuit 170 may receive the data “DATA” from the memory controller 11 or may transmit the data “DATA” to the memory controller 11. For example, the input/output circuit 170 may transmit the write data WDT and the write parity data WPRT included in the received data “DATA” to the memory ECC circuit 110. For example, the input/output circuit 170 may transmit, to the memory controller 11, the data “DATA” including the read data RDT stored in the memory cell array 120 and the read parity data RPRT received from the memory ECC circuit 110.

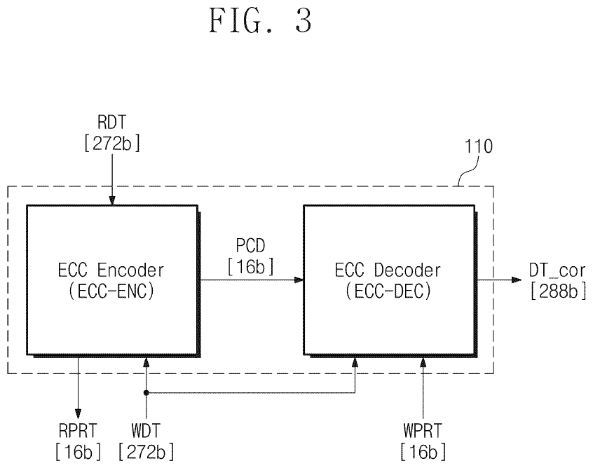

FIG. 3 is a block diagram for describing an operation of a memory ECC circuit of FIG. 2. Referring to FIGS. 2 and 3, the memory ECC circuit 110 may include an ECC encoder circuit (“ECC encoder”) ECC-ENC and an ECC decoder circuit (“ECC decoder”) ECC-DEC. The ECC encoder ECC-ENC may generate the read parity data RPRT by performing ECC encoding on the read data RDT stored in the memory cell array 120. For example, the ECC encoder ECC-ENC may generate the read parity data RPRT of 16 bits by performing ECC encoding on the read data RDT of 272 bits stored in the memory cell array 120. The read data RDT and the read parity data RPRT may be transmitted to the memory controller 11 through the input/output circuit 170.

Also, the ECC encoder ECC-ENC may generate parity check data PCD by performing H-matrix-based ECC encoding on the write data WDT transmitted from the memory controller 11 through the input/output circuit 170. For example, the ECC encoder ECC-ENC may generate the parity check data PCD of 16 bits by performing ECC encoding on the write data WDT of 272 bits. The ECC encoder ECC-ENC may transmit the parity check data PCD to the ECC decoder ECC-DEC.

In an embodiment, the ECC encoder ECC-ENC may be configured to perform ECC encoding based on the H-matrix.

The ECC decoder ECC-DEC may output error-corrected data DT_cor by performing ECC decoding based on the write data WDT and the write parity data WPRT transmitted from the memory controller 11 through the input/output circuit 170 and the parity check data PCD transmitted from the ECC encoder ECC-ENC. For example, the ECC decoder ECC-DEC may generate the error-corrected data DT_cor of 288 bits by performing ECC decoding based on the write data WDT of 272 bits, the write parity data WPRT of 16 bits, and the parity check data PCD of 16 bits. The error-corrected data DT_cor may be data obtained by correcting an error of the write data WDT or the parity check data PCD.

In an embodiment, the ECC decoder ECC-DEC may be configured to perform ECC decoding based on the H-matrix.

The numbers of bits of the read data RDT, the read parity data RPRT, the parity check data PCD, the write data WDT, the write parity data WPRT, and the error-corrected data DT_cor are illustrated in FIG. 3 as an example, but the present disclosure is not limited thereto. That is, the numbers of bits of the read data RDT, the read parity data RPRT, the parity check data PCD, the write data WDT, the write parity data WPRT, and the error-corrected data DT_cor may be variously changed or modified depending on a manner of implementation.

In an embodiment, only 256 bits among the 272 bits of the write data WDT may be valid data bits. In this case, the ECC encoder ECC-ENC may be configured to generate the parity check data PCD by performing ECC encoding only on the valid data of 256 bits. Also, the ECC decoder ECC-DEC may be configured to output the error-corrected data DT_cor of 272 bits by performing ECC decoding only on the valid data of 256 bits and the parity check data PCD of 16 bits.

An example of the memory ECC circuit 110 of FIG. 2 is illustrated in FIG. 3. The controller ECC circuit 11a of FIG. 1 may have a configuration similar or identical to the memory ECC circuit 110. Thus, the controller ECC circuit 11a may include an ECC encoder and an ECC decoder. The ECC encoder may generate write parity data by performing ECC encoding on write data transmitted from the external host. Also, the ECC encoder may generate parity check data by performing ECC encoding on read data received from the memory device 100. The ECC decoder may generate error-corrected data by performing ECC decoding based on the read data, the parity check data, and read parity data corresponding to the read data.

For convenience of description and for brevity of drawing, the following drawings are illustrated in terms of the memory ECC circuit 110, but a configuration and an operation of the controller ECC circuit 11a may be implemented identical to those of the memory ECC circuit 110.

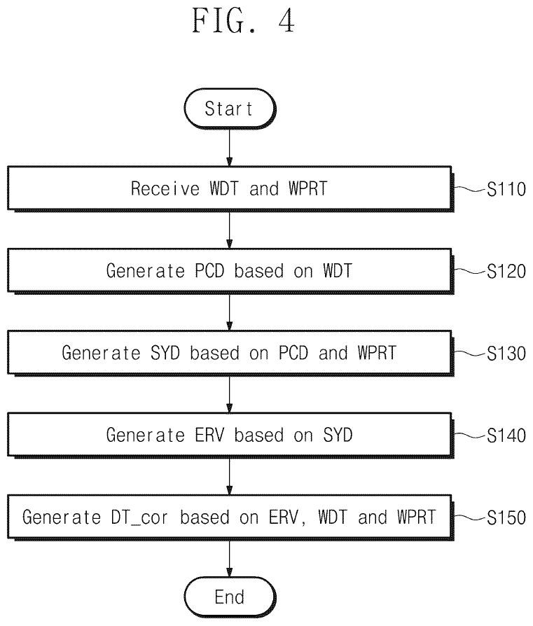

FIG. 4 is a flowchart illustrating an operation of an ECC circuit of FIG. 3. Referring to FIGS. 1, 3, and 4, in operation S110, the memory ECC circuit 110 may receive the write data WDT and the write parity data WPRT from the memory controller 11. For example, the write parity data WPRT may be data generated by the ECC encoder of the controller ECC circuit 11a.

In operation S120, the memory ECC circuit 110 may generate the parity check data PCD based on the write data WDT. In an embodiment, the ECC encoder ECC-ENC may generate the parity check data PCD by performing H-matrix-based ECC encoding on the write data WDT.

In operation S130, the memory ECC circuit 110 may generate a syndrome SYD based on the parity check data PCD and the write parity data WPRT. In general, a syndrome is a specific pattern calculated from received data, which may indicate the presence and location of errors within the data. The syndrome pattern may allow a decoder to identify and correct the errors. In an embodiment, the ECC decoder ECC-DEC may generate the syndrome SYD of 16 bits by performing a bitwise XOR operation on the parity check data PCD and the write parity data WPRT.

In operation S140, the memory ECC circuit 110 may generate an error vector ERV based on the syndrome SYD. To this end, the ECC decoder ECC-DEC may decode the syndrome SYD to generate the error vector ERV. In an embodiment, the ECC decoder ECC-DEC may detect an error position(s) of the write data WDT and the write parity data WPRT, by comparing the H-matrix and the syndrome SYD. Thus, the error vector ERV may include information about an error position(s) of the write data WDT and the write parity data WPRT.

In operation S150, the memory ECC circuit 110 may generate the error-corrected data DT_cor based on the error vector ERV, the write data WDT, and the write parity data WPRT. The memory ECC circuit 110 may output the error-corrected data DT_cor by performing the bitwise XOR operation on the data WDT and WPRT and the error vector ERV.

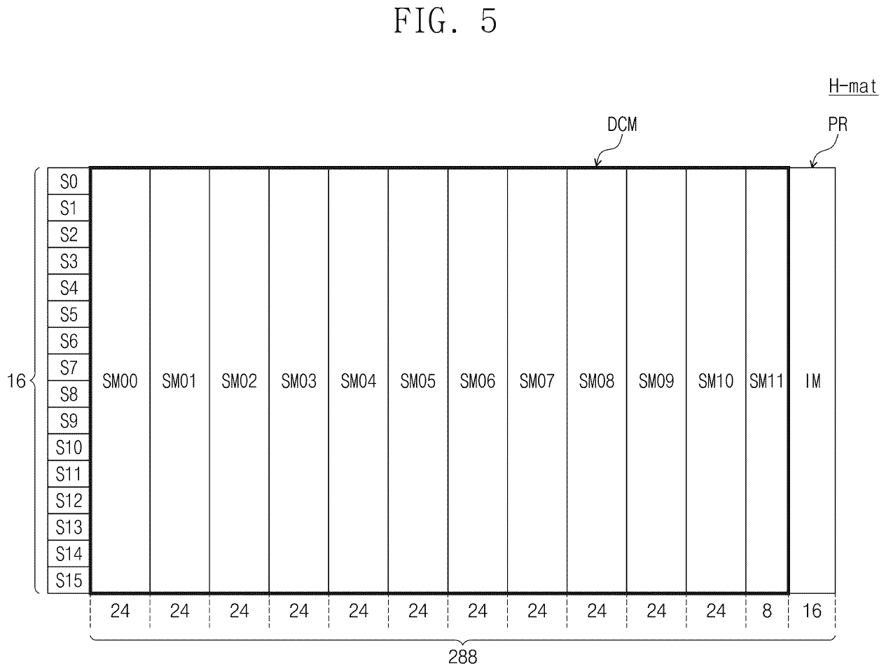

FIG. 5 is a diagram illustrating an example of a portion of an H-matrix “H-mat” used by a memory ECC circuit of FIG. 3. The H-matrix H-mat described with reference to FIG. 5 is an example of a portion of the H-matrix for single bit error correction (SEC). However, the present disclosure is not limited thereto. For example, it may be understood that the H-matrix according to the present disclosure may be variously modified or changed depending on a manner of implementation of the memory ECC circuit 110.

The H-matrix H-mat may include a data check matrix DCM and a parity matrix PR. The data check matrix DCM may be a matrix of dimension 16×272. The parity matrix PR may be an identity matrix IM of dimension 16×16. Meanwhile, rows of the H-matrix H-mat may respectively correspond to bits S0, S1, S2, S3, S4, S5, S6, S7, S8, S9, S10, S11, S12, S13, S14, and S15 of a 16-bit syndrome SYD.

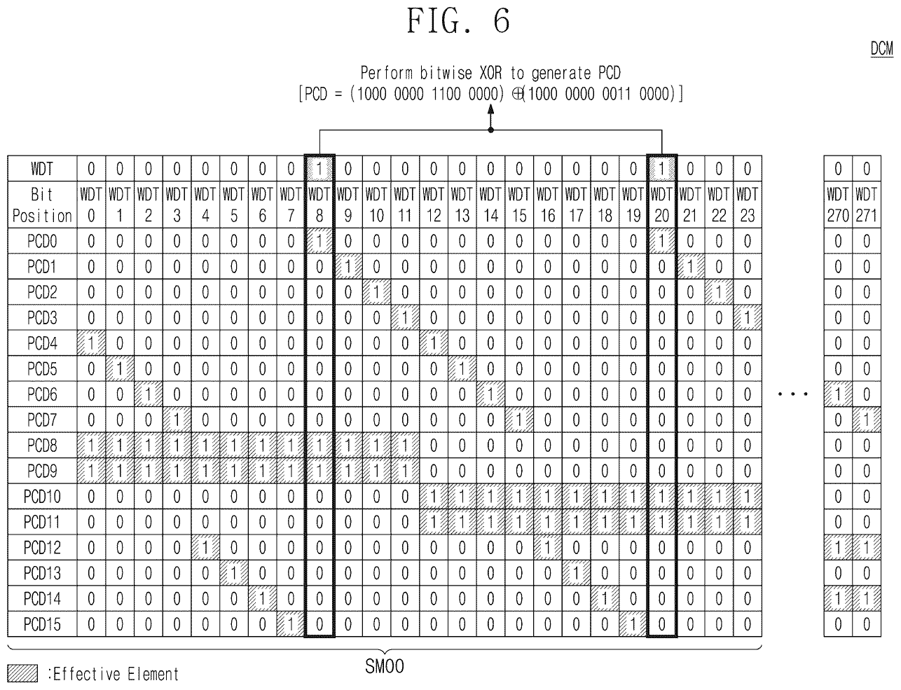

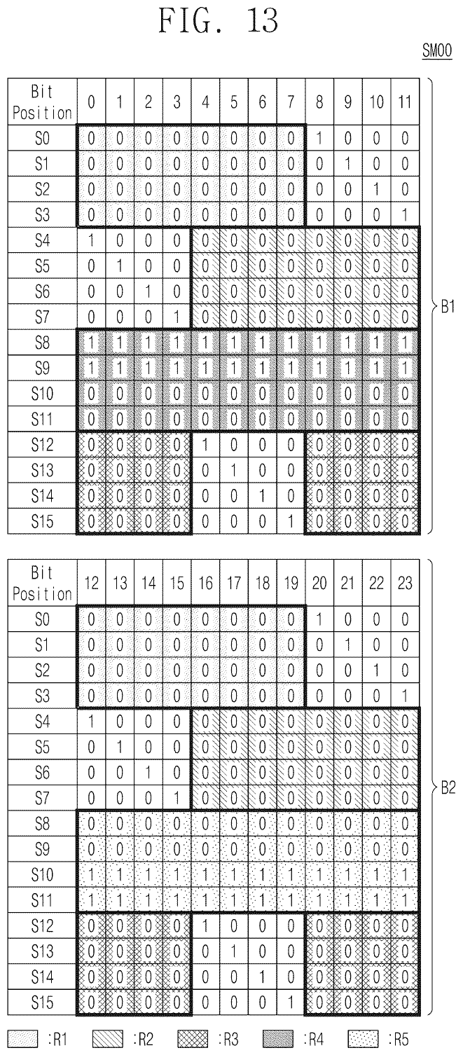

The data check matrix DCM may include a plurality of sub-matrices SM00 to SM11. Each of the 0-th to tenth sub-matrices SM00 to SM10 may be of dimension 16×24. The eleventh sub-matrix SM11 may be of dimension 16×8. However, the present disclosure is not limited thereto. Meanwhile, each of the plurality of sub-matrices SM00 to SM11 may include a plurality of “effective elements”. Also, each of the plurality of sub-matrices SM00 to SM11 may include a plurality of common regions. The effective elements and the common regions will be described in detail with reference to FIGS. 6 and 13.

According to the present disclosure, the ECC encoder ECC-ENC may be configured to perform ECC encoding through an operation corresponding to the effective elements, but not the common regions. Also, the ECC decoder ECC-DEC may include a common (shared) arithmetic circuit which performs an operation corresponding to the common regions. According to the above description, the ECC encoder ECC-ENC and the ECC decoder ECC-DEC may omit unnecessary arithmetic circuits. Accordingly, the area of the memory ECC circuit 110 may be reduced.

FIG. 6 is a diagram for describing an ECC encoding operation. In detail, FIG. 6 illustrates an example of the data check matrix DCM. Referring to FIGS. 3, 5, and 6, for a write operation, the ECC encoder ECC-ENC may generate the parity check data PCD by performing ECC encoding based on the write data WDT and the data check matrix DCM. Also, for a read operation, the ECC encoder ECC-ENC may generate the parity check data PCD by performing ECC encoding on the read data RDT and the data check matrix DCM.

Columns of the data check matrix DCM may respectively correspond to bits (e.g., WDT0 to WDT271) of the write data WDT. Rows of the data check matrix DCM may respectively correspond to bits (e.g., PCD0 to PCD15) of the parity check data PCD. Also, although not illustrated in FIG. 6, each column of the data check matrix DCM may correspond to a respective bit of the read data RDT. Rows of the data check matrix DCM may respectively correspond to bits of the read parity data RPRT.

Below, to describe embodiments of the present disclosure briefly and clearly, the description will be given as some data values or bit values are at a specific level or a specific bit level (e.g., “1” or “0”). However, the present disclosure is not limited thereto. Data values or bit values used in the specification may be variously modified or changed in other examples.

The ECC encoding may be performed based on a transpose matrix (hereinafter referred to as a “parity generator matrix”) of the data check matrix DCM. For example, the parity generator matrix may be of dimension 272×16. For example, the parity check data PCD may correspond to a result of multiplying the write data WDT of 272 bits (e.g., a matrix of dimension 1×272) and the parity generator matrix together.

The matrix product operation which is based on the parity generator matrix and the write data WDT may be implemented through the bitwise XOR operation on column vectors of the data check matrix DCM, which correspond to bits being “1” from among the bits of the write data WDT. For example, as illustrated in FIG. 6, only the eighth bit WDT8 and the twentieth bit WDT20 among the bits of the write data WDT may have a bit value of “1” (i.e., WDT(272b)=“0000 0000 1000 0000 0000 1000 . . . 0000”, where WDT(272b) denotes write data of 272 bits). In this case, the parity check data PCD may be a result (e.g., PCD(16b)=“0000 0000 1111 0000”) of performing the bitwise XOR operation on column vectors (e.g., “1000 0000 1100 0000” and “1000 0000 0011 0000”) respectively corresponding to the eighth bit WDT8 and the twentieth bit WDT20 from among the column vectors of the 0-th sub-matrix SM00.

Meanwhile, the data check matrix DCM may include a plurality of “effective elements”. For example, elements being “1” from among the elements of the data check matrix DCM may be referred to as such effective elements. As described above, the matrix product operation for ECC encoding may be the XOR operation on column vectors of the data check matrix DCM, which correspond to bits (e.g., WDT8 and WDT20) being “1” from among the bits of the write data WDT. Accordingly, each of bit values of the bits PCD0 to PCD15 of the parity check data PCD may be determined based on bit values of bits, which correspond to effective elements associated with each of the bits PCD0 to PCD15, from among the bits WDT0 to WDT271 of the write data WDT.

In an example differing from that shown in FIG. 6, all the remaining elements of the data check matrix DCM other than the elements of the 0-th sub-matrix SM00 are “0”. In this case, a bit value of the 0-th bit PCD0 of the parity check data PCD may be determined based on bit values of the bits WDT8 and WDT20 of the write data WDT, which correspond to effective elements (i.e., effective elements of the first row of the data check matrix DCM) associated with the 0-th bit PCD0. For example, in the example of FIG. 6, when both the eighth bit WDT8 and the twentieth bit WDT20 are “1”, the 0-th bit PCD0 of the parity check data PCD may be “0”. For example, unlike the example of FIG. 6, when both the eighth bit WDT8 and the twentieth bit WDT20 are “0”, the 0-th bit PCD0 of the parity check data PCD may be “0”. For example, unlike the example of FIG. 6, when only one of the eighth bit WDT8 and the twentieth bit WDT20 is “0”, the 0-th bit PCD0 of the parity check data PCD may be “1”. Accordingly, the 0-th bit PCD0 of the parity check data PCD may be a result of performing the XOR operation on the eighth bit WDT8 and the twentieth bit WDT20 of the write data WDT.

Likewise, the first bit PCD1 of the parity check data PCD may be a result of performing the XOR operation on the ninth bit WDT9 and the twenty-first bit WDT21 corresponding to effective elements of the second row of the data check matrix DCM. Also, the eighth bit PCD8 of the parity check data PCD may be a result (e.g., “1”) of performing the XOR operation on the 0-th to eleventh bits WDT0 to WDT11 (e.g., “0000 0000 1000”) of the write data WDT that correspond to effective elements of the ninth row of the data check matrix DCM.

That is, each bit of the parity check data PCD may be a result of performing the XOR operation on bits of the write data WDT that correspond to effective elements of a row of the data check matrix DCM associated with each bit of the parity check data PCD.

Accordingly, the matrix product operation for ECC encoding may be implemented through the XOR operation on bits of the write data WDT, which correspond to effective elements of the data check matrix DCM. According to the present disclosure, the ECC encoder ECC-ENC may be configured to generate the parity check data PCD (i.e., to perform ECC encoding) by performing the XOR operation only on bits corresponding to effective elements of the data check matrix DCM from among the bits WDT0 to WDT271 of the write data WDT. Accordingly, the ECC encoder ECC-ENC may omit unnecessary arithmetic circuits. As a result, the area occupied by the ECC encoder ECC-ENC may be reduced.

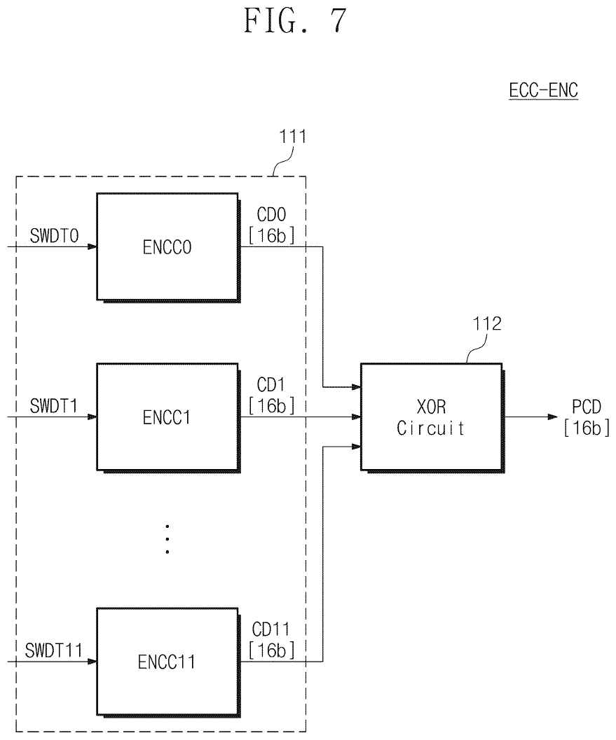

FIG. 7 is a block diagram for describing an ECC encoder of FIG. 3. Referring to FIGS. 3 and 7, the ECC encoder ECC-ENC may include a check data generator 111 and an XOR circuit 112. The check data generator 111 may be configured to output 16-bit check data CD0 to CD11 by performing ECC encoding on the sub-matrices SM00 to SM11 of the data check matrix DCM based on the write data WDT.

The check data generator 111 may include encoding circuits ENCC0 to ENCC11. The encoding circuits ENCC0 to ENCC11 may respectively correspond to the sub-matrices SM00 to SM11 of the data check matrix DCM. The 0-th encoding circuit ENCC0 may be configured to output the 0-th check data CD0 of 16 bits by performing ECC encoding corresponding to the 0-th sub-matrix SM00 based on 0-th sub-write data SWDT0. The first encoding circuit ENCC1 may be configured to output the first check data CD1 of 16 bits by performing ECC encoding corresponding to the first sub-matrix SM01 based on first sub-write data SWDT1. The eleventh encoding circuit ENCC11 may be configured to output the eleventh check data CD11 of 16 bits by performing ECC encoding corresponding to the eleventh sub-matrix SM11 based on eleventh sub-write data SWDT11.

For example, the 0-th sub-write data SWDT0 may be formed of bits (e.g., WDT0 to WDT23) of the write data WDT; the first sub-write data SWDT1 may be formed of bits (e.g., WDT24 to WDT47) of the write data WDT; and the eleventh sub-write data SWDT11 may be formed of bits (e.g., WDT264 to WDT271) of the write data WDT. Thus, each of the sub-write data SWDT0 to SWDT11 may be formed of bits of the write data WDT, which are associated with the corresponding sub-matrix (e.g., one of SM00 to SM11).

Each of the check data CD0 to CD11 may be a result of performing ECC encoding on the corresponding sub-matrix among the sub-matrices SM00 to SM11 of the data check matrix DCM. The XOR circuit 112 may be configured to output the parity check data PCD of 16 bits by performing the bitwise XOR operation on the check data CD0 to CD11. In an embodiment, the XOR circuit 112 may include a plurality of XOR gates for performing the bitwise XOR operation on the check data CD0 to CD11.

In an embodiment, in the read operation, the ECC encoder ECC-ENC may generate the read parity data RPRT in a method similar to the method of generating the parity check data PCD. To this end, the check data generator 111 may generate the check data CD0 to CD11 by performing ECC encoding on sub-matrices of the data check matrix DCM based on the read data RDT. The XOR circuit 112 may generate the read parity data RPRT by performing the bitwise XOR operation on the check data CD0 to CD11.

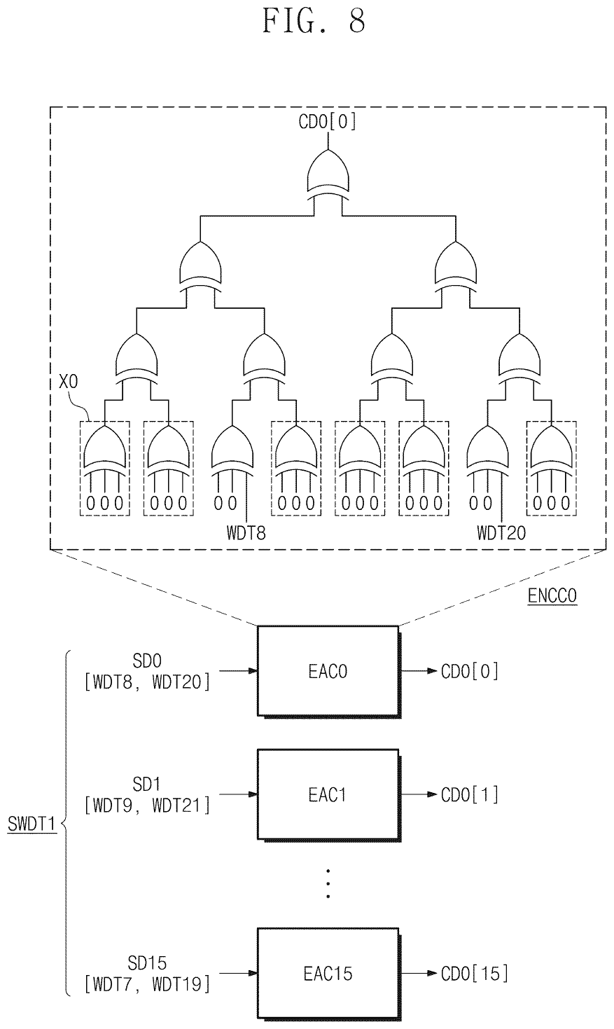

FIG. 8 is a logic gate diagram for describing an example of a 0-th encoding circuit of FIG. 7, according to a comparative example. Referring to FIGS. 7 and 8, the 0-th encoding circuit ENCC0 may include encoding arithmetic circuits EAC0 to EAC15. The encoding arithmetic circuits EAC0 to EAC15 may be configured to output bits CD0[0] to CD0[15] of the 0-th check data CD0 by performing the XOR operation based on sub-data SD0 to SD15 included in the first sub-write data SWDT1.

The 0-th encoding arithmetic circuit EAC0 may be configured to output the 0-th bit CD0[0] of the 0-th check data CD0 by performing the XOR operation based on the 0-th sub-data SD0; the first encoding arithmetic circuit EAC1 may be configured to output the first bit CD0[1] of the 0-th check data CD0 by performing the XOR operation based on the first sub-data SD1; and the fifteenth encoding arithmetic circuit EAC15 may be configured to output the fifteenth bit CD0[15] of the 0-th check data CD0 by performing the XOR operation based on the fifteenth sub-data SD15.

As described above, the 0-th encoding circuit ENCC0 may perform ECC encoding corresponding to the 0-th sub-matrix SM00 of the data check matrix DCM. The 0-th to fifteenth encoding circuits EAC0 to EAC15 may generate the bits CD0[0] to CD0[15] of the 0-th check data CD0 by performing operations corresponding to the rows of the 0-th sub-matrix SM00. In detail, the 0-th encoding arithmetic circuit EAC0 may be configured to perform an operation corresponding to the first row of the 0-th sub-matrix SM00; the first encoding arithmetic circuit EAC1 may be configured to perform an operation corresponding to the second row of the 0-th sub-matrix SM00; and the fifteenth encoding arithmetic circuit EAC15 may be configured to perform an operation corresponding to the sixteenth row of the 0-th sub-matrix SM00.

Meanwhile, the 0-th sub-data SD0 may be formed of the bits WDT8 and WDT20 corresponding to the effective elements of the first row of the 0-th sub-matrix SM00 from among the bits of the first sub-write data SWDT1. The first sub-data SD1 may be formed of the bits WDT9 and WDT21 corresponding to the effective elements of the second row of the 0-th sub-matrix SM00 from among the bits of the first sub-write data SWDT1 (as shown in FIG. 6). The fifteenth sub-data SD15 may be formed of the bits WDT7 and WDT19 corresponding to positions of the effective elements of the sixteenth row of the 0-th sub-matrix SM00 from among the bits of the first sub-write data SWDT1 (as shown in FIG. 6).

For example, each of the encoding arithmetic circuits EAC0 to EAC15 may be configured to perform the XOR operation through a 4-stage XOR arithmetic circuit. That is, each of the encoding arithmetic circuits EAC0 to EAC15 may include 15 XOR gates. In this case, the 0-th encoding arithmetic circuit EAC0 may include a plurality of XOR gates X0 whose inputs receive “0”. In this case, a bit value of the 0-th bit CD0 of the 0-th check data CD0 may be determined based just on the bit values of the eighth bit WDT8 and the twentieth bit WDT20 of the write data WDT. Accordingly, when the encoding arithmetic circuit (e.g., EAC0) is implemented as illustrated in FIG. 8, the 0-th encoding arithmetic circuit EAC0 may include a plurality of XOR gates (e.g., X0) performing an unnecessary operation. This may mean that the area of the 0-th encoding circuit ENCC0 becomes excessively large.

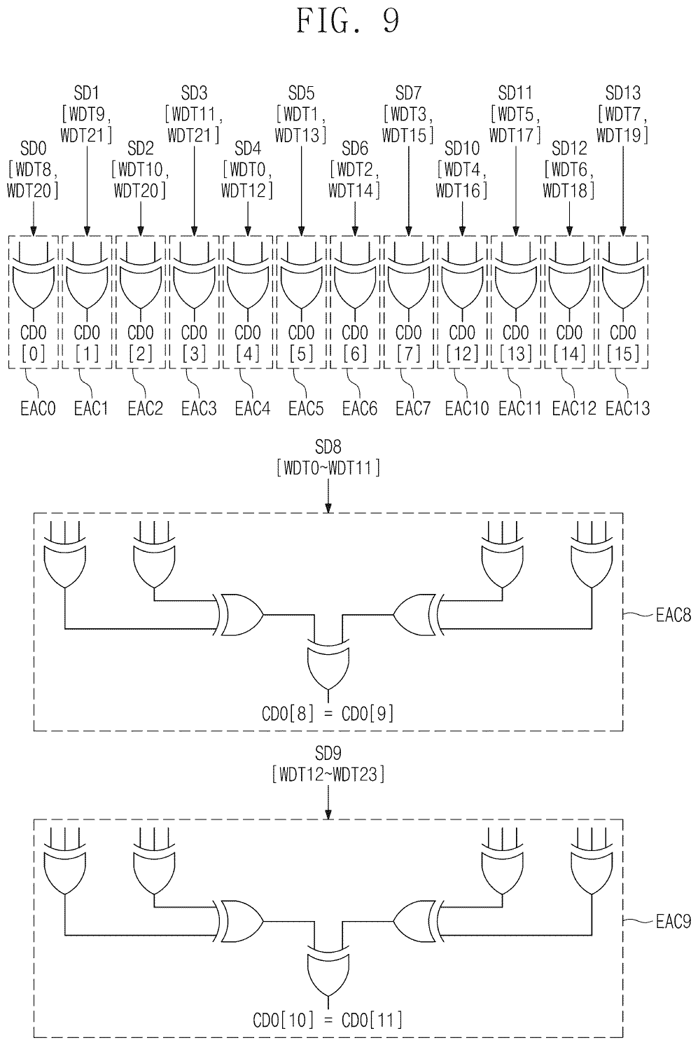

FIG. 9 is a logic circuit diagram of a 0-th encoding circuit of FIG. 7, according to an embodiment. Referring to FIGS. 6, 7, and 9, the 0-th encoding circuit ENCC0 may include encoding arithmetic circuits EAC0 to EAC13, which collectively have significantly less logic gates relative to the comparative example of FIG. 8. The encoding arithmetic circuits EAC0 to EAC13 may be configured to output the bits CD0[0] to CD0[15] of the 0-th check data CD0 by performing the XOR operation based on the sub-data SD0 to SD13 included in the first sub-write data SWDT1. The sub-data SD0 to SD13 may be formed of some of the bits WDT0 to WDT24 of the first sub-write data SWDT1.

Each of the encoding arithmetic circuits EAC0 to EAC13 may be configured to perform the XOR operation corresponding to a respective row of the 0-th sub-matrix SM00. The 0-th to seventh encoding arithmetic circuits EAC0 to EAC7 may generate the bits CD0[0] to CD0[7] of the 0-th check data CD0 by performing the XOR operations corresponding to the first to eighth rows of the 0-th sub-matrix SM00. The eighth encoding arithmetic circuit EAC8 may generate the eighth bit CD0[8] and the ninth bit CD0[9] of the 0-th check data CD0 by performing the XOR operations corresponding to the ninth and tenth rows of the 0-th sub-matrix SM00. The ninth encoding arithmetic circuit EAC9 may generate the tenth bit CD0[10] and the eleventh bit CD0[11] of the 0-th check data CD0 by performing the XOR operations corresponding to the eleventh and twelfth rows of the 0-th sub-matrix SM00. The tenth to thirteenth encoding arithmetic circuits EAC10 to EAC13 may generate the twelfth to fifteenth bits CD0[12] to CD0[15] of the 0-th check data CD0 by performing the XOR operations corresponding to the thirteenth to sixteenth rows of the 0-th sub-matrix SM00.

In an embodiment, the encoding arithmetic circuits EAC0 to EAC13 may be configured to perform the XOR operations only on bits corresponding to effective elements from among the bits of the write data WDT.

The 0-th sub-data SD0 may be 2-bit data formed of the bits WDT8 and WDT20 of the write data WDT, which correspond to effective elements among the elements of the first row of the 0-th sub-matrix SM00. The 0-th encoding arithmetic circuit EAC0 may be implemented with one XOR gate configured to receive the 0-th sub-data SD0 of 2 bits and to output the 0-th bit CD0[0] of the 0-th check data CD0. In other words, the 0-th encoding arithmetic circuit EAC0 may perform the same operation as the 0-th encoding arithmetic circuit EAC0 having fifteen XOR gates of FIG. 8 through one XOR gate. Thus, the 0-th encoding arithmetic circuit EAC0 may omit an arithmetic circuit (e.g., fourteen out of the fifteen XOR gates X0 of FIG. 8) for an unnecessary operation.

Likewise, each of the first to seventh sub-data SD1 to SD7 may be formed of bits of the write data WDT, which correspond to effective elements among the elements of each of the second to eighth rows of the 0-th sub-matrix SM00, and each of the tenth to thirteenth sub-data SD10 to SD13 may be formed of bits of the write data WDT, which correspond to effective elements among the elements of each of the thirteenth to sixteenth rows of the 0-th sub-matrix SM00. As illustrated in FIG. 6, each of the first to eighth rows and the eleventh to sixteenth rows of the data check matrix DCM may include only two effective elements. Accordingly, each of the first to seventh sub-data SD1 to SD7 and the tenth to thirteenth sub-data SD10 to SD13 may be 2-bit data.

Accordingly, each of the first to seventh encoding arithmetic circuits EAC1 to EAC7 and the tenth to thirteenth encoding arithmetic circuits EAC10 to EAC13 may be implemented with one XOR gate like the 0-th encoding arithmetic circuit EAC0. That is, each of the first to seventh encoding arithmetic circuits EAC1 to EAC7 and the tenth to thirteenth encoding arithmetic circuits EAC10 to EAC13 may omit an arithmetic circuit (e.g., fourteen out of the fifteen XOR gates X0 of FIG. 8) for an unnecessary operation.

Meanwhile, as illustrated in FIG. 6, the ninth row and the tenth row of the 0-th sub-matrix SM00 may have the same data pattern. Elements corresponding to the 0-th to eleventh bits WDT0 to WDT11 of the write data WDT from among the elements of the ninth and tenth rows may be effective elements. Accordingly, the eighth sub-data SD8 may be formed of the 0-th to eleventh bits WDT0 to WDT11 of the write data WDT. Also, the eighth encoding arithmetic circuit EAC8 may be a 3-stage XOR arithmetic circuit configured to perform the XOR operation on the eighth sub-data SD8. An output signal of the eighth encoding arithmetic circuit EAC8 may be used as the eighth bit CD0[8] and the ninth bit CD0[9] of the 0-th check data CD0. Hence, according to an embodiment of the present disclosure, the eighth encoding arithmetic circuit EAC8 may be configured to output the eighth bit CD0[8] and the ninth bit CD0[9] by performing an operation corresponding to the ninth and tenth rows of the 0-th sub-matrix SM00, which have the same data pattern, only once through one arithmetic circuit.

Also, as illustrated in FIG. 6, the eleventh row and the twelfth row of the 0-th sub-matrix SM00 may have the same data pattern. Elements corresponding to the twelfth to twenty-third bits WDT12 to WDT23 of the write data WDT from among the elements of the eleventh and twelfth rows may be effective elements. Accordingly, the ninth encoding arithmetic circuit EAC8 may be a 3-stage XOR arithmetic circuit configured to perform the XOR operation on the ninth sub-data SD9. The ninth sub-data SD9 may be formed of the twelfth to twenty-third bits WDT12 to WDT23 of the write data WDT. An output signal of the ninth encoding arithmetic circuit EAC9 may be used as the tenth bit CD0[10] and the eleventh bit CD0[11] of the 0-th check data CD0. Therefore, according to an embodiment of the present disclosure, the ninth encoding arithmetic circuit EAC9 may be configured to output the tenth bit CD0[10] and the eleventh bit CD0[11] of the 0-th check data CD0 by performing an operation corresponding to the eleventh and twelfth rows of the 0-th sub-matrix SM00, which have the same data pattern, only once through one arithmetic circuit.

FIG. 9 shows only the 0-th encoding circuit ENCC0. The other encoding circuits ENCC1 to ENCC11 of FIG. 7 may be implemented based on a structure (i.e., effective elements of each sub-matrix) of the corresponding sub-matrices SM01 to SM11, like the 0-th encoding circuit ENCC0.

As described above, an encoding circuit (e.g., ENCC0) according to an embodiment of the present disclosure may be configured to perform the XOR operation only on bits of the write data WDT, which correspond to effective elements of a relevant sub-matrix (e.g., SM00). Accordingly, unlike the case of FIG. 8, the encoding circuit (e.g., ENCC0) may omit an unnecessary arithmetic circuit (e.g., many XOR gates X0 of FIG. 8). Also, the encoding circuit (e.g., ENCC0) may be configured to perform the XOR operation on rows having the same data pattern from among rows of the relevant sub-matrix (e.g., SM00) only once through one arithmetic circuit (e.g., EAC8). According to the above description, the encoding circuit (e.g., ENCC0) of FIG. 9 according to the present disclosure may have a significantly smaller area compared to the encoding circuit of FIG. 8.

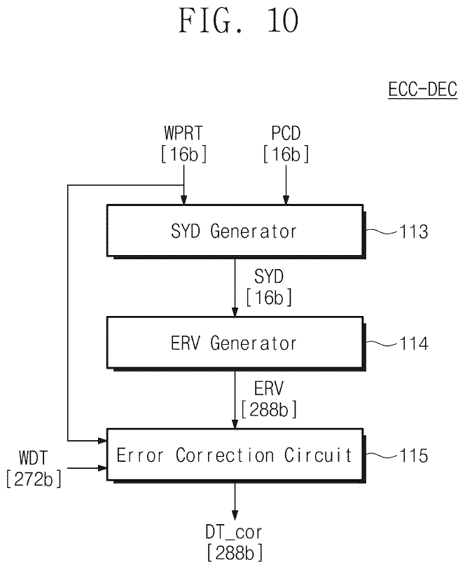

FIG. 10 is a functional block diagram of an ECC decoder of FIG. 3 according to an example. The ECC decoder of FIG. 10 may be configured to perform operation S120 to operation S150 of FIG. 4. Referring to FIGS. 3 and 10, the ECC decoder may include a syndrome generator circuit (“syndrome generator”) 113, an error vector generator circuit (“error vector generator”) 114, and an error correction circuit 115.

The syndrome generator 113 may generate the syndrome SYD based on the write parity data WPRT of e.g., 16 bits and the parity check data PCD of e.g., 16 bits. The write parity data WPRT may be data received from the memory controller 11. The parity check data PCD may be data received from the ECC encoder ECC-ENC of the memory ECC circuit 110. In an embodiment, the syndrome generator 113 may generate the syndrome SYD of 16 bits by performing a bitwise XOR operation on the write parity data WPRT of 16 bits and the parity check data PCD of 16 bits.

The error vector generator 114 may be configured to perform ECC decoding on a syndrome to generate an error vector. To this end, the error vector generator 114 may generate the error vector ERV by comparing the H-matrix H-mat and the syndrome SYD.

The error vector ERV may have the size of e.g., 288 bits and may include information about an error position(s) of the write data WDT and the write parity data WPRT.

The error correction circuit 115 may correct an error of the write data WDT and the write parity data WPRT by using the error vector ERV. The error correction circuit 115 may output the error-corrected data DT_cor by performing the bitwise XOR operation on the error vector ERV and the 288-bit data including the write data WDT and the write parity data WPRT.

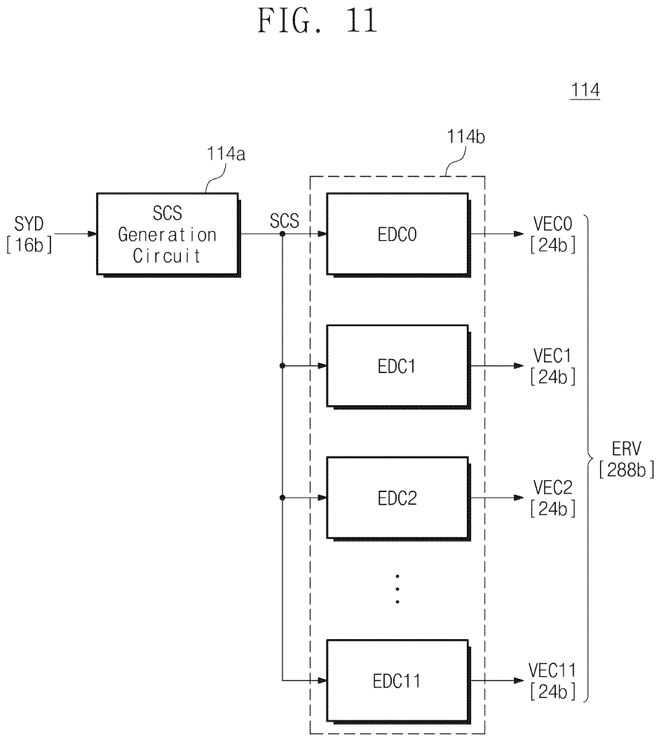

FIG. 11 is a functional block diagram of an error vector generator of FIG. 10 according to an example. Referring to FIGS. 10 and 11, the error vector generator 114 may include a syndrome comparison signal (SCS) generation circuit 114a and an error vector generation circuit 114b.

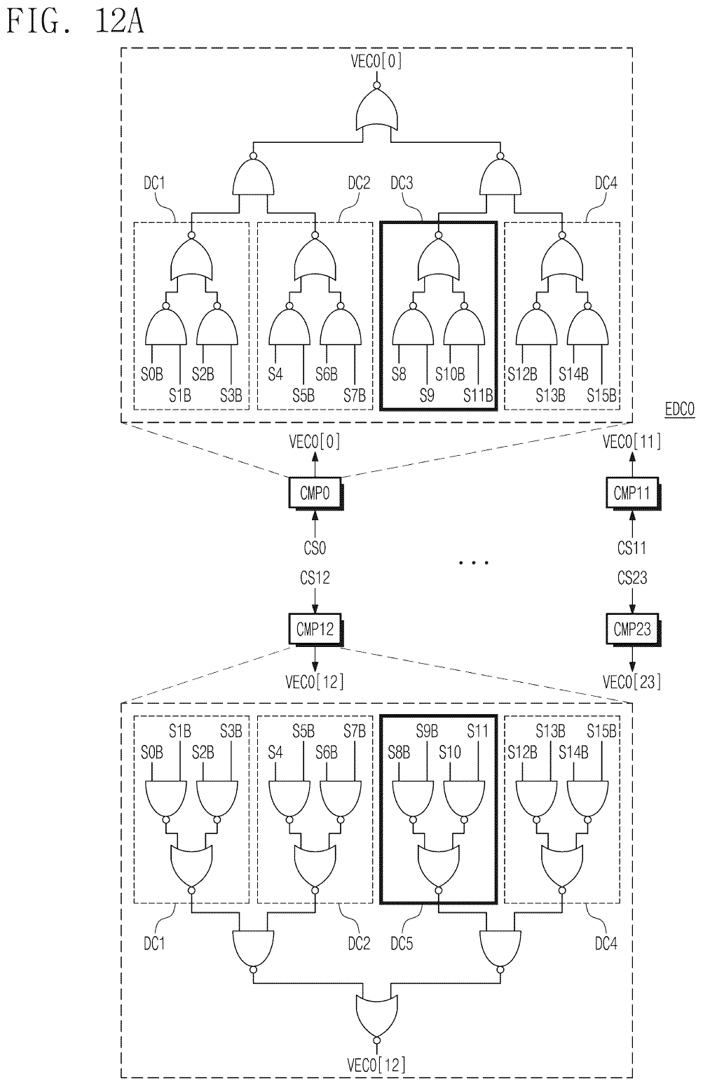

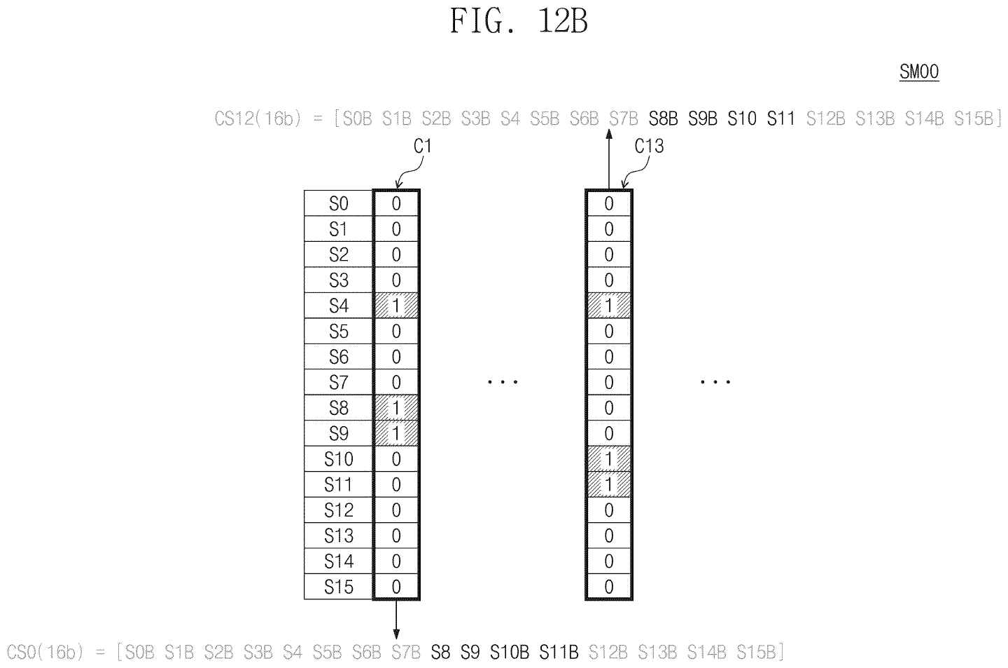

The syndrome comparison signal generation circuit 114a may generate a syndrome comparison signal SCS based on the H-matrix H-mat and the syndrome SYD. The syndrome comparison signal SCS may be a signal for comparing each column of the H-matrix H-mat and the syndrome SYD. The syndrome comparison signal generation circuit 114a may generate the syndrome comparison signal SCS by inverting bits, which do not correspond to effective elements, from among bits SYD0 to SYD15 of the syndrome SYD. The syndrome comparison signal SCS will be described in detail with reference to FIG. 12B.

The error vector generation circuit 114b may generate the error vector ERV by comparing each column of the H-matrix H-mat and the syndrome SYD based on the syndrome comparison signal SCS. For example, all the bits of the error vector ERV may be “0”. In this case, the error vector ERV may indicate that an error does not occur in the write data WDT and the write parity data WPRT. For example, only the second bit among the bits of the error vector ERV (e.g., the second bit of a 0-th vector VEC0 of the error vector ERV) may be “1”. In this case, the error vector ERV may indicate that the second bit WDT2 among the bits of the write data WDT is erroneous.

The error vector generation circuit 114b may include ECC decoding circuits EDC0 to EDC11. Each of the ECC decoding circuits EDC0 to EDC11 may be configured to compare a relevant sub-matrix (e.g., one of SM00 to SM11 and PR) of the H-matrix H-mat and the syndrome SYD.

For example, the 0-th ECC decoding circuit EDC0 may be configured to compare each column of the 0-thsub-matrix SM00 and the syndrome SYD to output a 0-th vector VEC0. The 0-thsub-matrix SM00 may include 24 columns. Accordingly, the 0-th vector VEC0 may include 24 bits. For example, the first ECC decoding circuit EDC1 may be configured to compare each column of the first sub-matrix SM01 and the syndrome SYD to output a first vector VEC1. For example, the second ECC decoding circuit EDC2 may be configured to compare each column of the second sub-matrix SM02 and the syndrome SYD to output a second vector VEC2. For example, the eleventh ECC decoding circuit EDC11 may be configured to compare each column of the eleventh sub-matrix SM11 and the syndrome SYD to output an eleventh vector VEC11. The 288-bit error vector ERV may be implemented by combining the 0-th to eleventh vectors VEC0 to VEC11.

FIG. 12A is a logic circuit diagram of an example of a 0-th ECC decoding circuit of FIG. 11, and FIG. 12B is a diagram for describing an example of a syndrome comparison signal of FIG. 11. For brevity of drawing and for convenience of description, in the following drawings, respective bits of the syndrome SYD are marked by S0, S1, S2, S3, S4, S5, S6, S7, S8, S9, S10, S11, S12, S13, S14, and S15, and inverted versions of the bits of the syndrome SYD are marked by S0B, S1B, S2B, S3B, S4B, S5B, S6B, S7B, S8B, S9B, S10B, S11B, S12B, S13B, S14B, and S15B.

Referring to FIGS. 11 and 12A, the 0-th ECC decoding circuit EDC0 may include comparison circuits CMP0 to CMP23. The comparison circuits CMP0 to CMP23 may be configured to compare respective columns of the 0-th sub-matrix SM00 and the syndrome SYD based on comparison signals CS0 to CS23 to output respective bits (e.g., VEC0[0] to VEC0[23]) of the 0-th vector VEC0. For example, the 0-th comparison circuit CMP0 may be configured to compare the first column of the 0-th sub-matrix SM00 and the syndrome SYD based on the 0-th comparison signal CS0 to output the 0-th bit VEC0[0] of the 0-th vector VEC0. The twelfth comparison circuit CMP12 may be configured to compare the thirteenth column of the 0-th sub-matrix SM00 and the syndrome SYD based on the twelfth comparison signal CS12 to output the twelfth bit VEC0[12] of the 0-th vector VEC0.

The comparison signals CS0 to CS23 may respectively correspond to the columns of the 0-th sub-matrix SM00. Each of the comparison signals CS0 to CS23 may be a signal for comparing the corresponding column and the syndrome SYD. The comparison signals CS0 to CS23 may be signals generated by inverting bits, which do not correspond to effective elements, from among the bits SYD0 to SYD15 of the syndrome SYD. Meanwhile, the syndrome comparison signal SCS of FIG. 11 may include the comparison signals CS0 to CS23.

Referring to FIG. 12B, elements belonging to the fifth row, the ninth row, and the tenth row from among elements of a first column C1 of the 0-th sub-matrix SM00 may be effective elements. Accordingly, the 0-th comparison signal CS0 of 16 bits may be formed of S0B, S1B, S2B, S3B, S4, S5B, S6B, S7B, S8, S9, S10B, S11B, S12B, S13B, S14B, and S15B. In detail, for example, when the syndrome SYD is “0010 1000 1010 0000”, the 0-th comparison signal CS0 may be “1101 1111 1001 1111”. Meanwhile, elements belonging to the fifth row, the eleventh row, and the twelfth row from among elements of a thirteenth column C13 of the 0-th sub-matrix SM00 may be effective elements. Accordingly, the twelfth comparison signal CS12 of 16 bits may be formed of S0B, S1B, S2B, S3B, S4, S5B, S6B, S7B, S8B, S9B, S10, S11, S12B, S13B, S14B, and S15B.

Returning to FIG. 12A, each of the 0-th to twenty-third comparison circuits CMP0 to CMP23 outputs “1” when all the bits of the received comparison signal (e.g., one of CS0 to CS23) are “1” and outputs “0 ” if not (i.e., when at least one of the bits of the received comparison signal is “0”). For example, the 0-th comparison circuit CMP0 receives the 0-th comparison signal CS0; the 0-th comparison circuit CMP0 outputs “1” when all the bits S0B, S1B, S2B, S3B, S4, S5B, S6B, S7B, S8, S9, S10B, S11B, S12B, S13B, S14B, and S15B of the 0-th comparison signal CS0 are “1” and outputs “0 ” if not (i.e., when at least one of the bits S0B, S1B, S2B, S3B, S4, S5B, S6B, S7B, S8, S9, S10B, S11B, S12B, S13B, S14B, and S15B of the 0-th comparison signal CS0 is “0”). The twelfth comparison circuit CMP12 receives the twelfth comparison signal CS12; the twelfth comparison circuit CMP12 outputs “1” when all the bits S0B, S1B, S2B, S3B, S4, S5B, S6B, S7B, S8B, S9B, S10, S11, S12B, S13B, S14B, and S15B of the twelfth comparison signal CS12 are “1” and outputs “0 ” if not (i.e., when at least one of the bits S0B, S1B, S2B, S3B, S4, S5B, S6B, S7B, S8B, S9B, S10, S11, S12B, S13B, S14B, and S15B of the twelfth comparison signal CS12 is “0”).

Meanwhile, as illustrated in FIG., 12A, each of the 0-th to twenty-third comparison circuits CMP0 to CMP23 may be implemented through a 1-stage NAND arithmetic circuit (e.g., composed of 8 NAND gates), a 1-stage NOR arithmetic circuit (e.g., composed of 4 NOR gates), a 1-stage NAND arithmetic circuit (e.g., composed of 2 NAND gates), and a 1-stage NOR arithmetic circuit (e.g., composed of one NOR gate).

The 0-th comparison circuit CMP0 may include a first decoding arithmetic circuit DC1 which performs a comparison operation corresponding to the bits S0B, S1B, S2B, and S3B of the 0-th comparison signal CS0, a second decoding arithmetic circuit DC2 which performs a comparison operation corresponding to the bits S4, S5B, S6B, and S7B of the 0-th comparison signal CS0, a third decoding arithmetic circuit DC3 which performs a comparison operation corresponding to the bits S8, S9, S10B, and S11B of the 0-th comparison signal CS0, and a fourth decoding arithmetic circuit DC4 which performs a comparison operation corresponding to the bits S12B, S13B, S14B, and S15B of the 0-th comparison signal CS0.

As illustrated FIG. 12B, the first column C1 and the thirteenth column C13 of the 0-th sub-matrix SM00 may be identical except for the elements of the ninth to twelfth rows. Accordingly, the 0-th comparison signal CS0 and the twelfth comparison signal CS12 may be identical except for the bits corresponding to the ninth to twelfth rows. That is, the twelfth comparison circuit CMP12 may include the first decoding arithmetic circuit DC1, the second decoding arithmetic circuit DC2, and the fourth decoding arithmetic circuit DC4 which perform the comparison operation on the bits S0B, S1B, S2B, S3B, S4, S5B, S6B, S7B, S8B, S13B, S14B, and S15B of the twelfth comparison signal CS12. Also, the twelfth comparison circuit CMP12 may include a fifth decoding arithmetic circuit DC5 for performing the comparison operation on the bits S8B, S9B, S10, and S11 of the twelfth comparison signal CS12.

Accordingly, the first comparison circuit CMP0 and the twelfth comparison circuit CMP12 may include the plurality of identical decoding arithmetic circuits DC1, DC2, and DC4 for performing the same operation. Likewise, the second to eleventh comparison circuits CMP2 to CMP11 and the thirteenth to twenty-third comparison circuits CMP13 to CMP23 may include a plurality of identical decoding arithmetic circuits for performing the same operation based on elements of each column of the 0-th sub-matrix SM00. Accordingly, the area of the 0-th ECC decoding circuit EDC0 may become excessively large.

FIG. 13 illustrates a 0-th sub-matrix of FIG. 5. Referring to FIG. 13, the 0-th sub-matrix SM00 may include a first sub-matrix B1 and a second sub-matrix B2. The first sub-matrix B1 is a sub-matrix corresponding to the first to eleventh columns of the 0-th sub-matrix SM00, and the second sub-matrix B2 is a sub-matrix corresponding to the twelfth to twenty-third columns of the 0-th sub-matrix SM00.

Meanwhile, the 0-th sub-matrix SM00 may include common regions R1 to R5. The first common region R1 may be a region corresponding to a first comparison operation for ECC decoding, the second common region R2 may be a region corresponding to a second comparison operation for ECC decoding, the third common region R3 may be a region corresponding to a third comparison operation for ECC decoding, the fourth common region R4 may be a region corresponding to a fourth comparison operation for ECC decoding, and the fifth common region R5 may be a region corresponding to a fifth comparison operation for ECC decoding. As illustrated in FIG. 13, the first sub-matrix B1 may be the same as the second sub-matrix B2 except for the fourth common region R4 and the fifth common region R5.

In an embodiment, the first comparison operation may be an operation of a decoding arithmetic circuit (e.g., the first decoding arithmetic circuit DC1 of FIG. 12A) which receives the bits S0B, S1B, S2B, and S3B of the syndrome comparison signal SCS as an input. The second comparison operation may be an operation of a decoding arithmetic circuit (e.g., the 1-stage NAND arithmetic circuit and the 1-stage NOR arithmetic circuit like the decoding arithmetic circuits DC1 to DC5 of FIG. 12A) which receives the bits S4B, S5B, S6B, and S7B of the syndrome comparison signal SCS as an input. The third comparison operation may be an operation of a decoding arithmetic circuit (e.g., the fourth decoding arithmetic circuit DC4 of FIG. 12A) which receives the bits S12B, S13B, S14B, and S15B of the syndrome comparison signal SCS as an input. The fourth comparison operation may be an operation of a decoding arithmetic circuit (e.g., the third decoding arithmetic circuit DC3 of FIG. 12A) which receives the bits S8, S9, S10B, and S11B of the syndrome comparison signal SCS as an input. The fifth comparison operation may be an operation of a decoding arithmetic circuit (e.g., the fifth decoding arithmetic circuit DC5 of FIG. 12A) which receives the bits S8B, S9B, S10, and S11 of the syndrome comparison signal SCS as an input.

According to an embodiment of the present disclosure, each of the ECC decoding circuits EDC0 to EDC11 may be configured to perform operations on common regions of a relevant sub-matrix by using one arithmetic circuit. The one arithmetic circuit may be referred to herein as a common arithmetic circuit or a shared arithmetic circuit. Accordingly, the ECC decoding circuits EDC0 to EDC11 may omit a plurality of identical decoding arithmetic circuits. As a result, the size of, and the area occupied by, the ECC decoding circuits EDC0 to EDC11 may be reduced. An ECC decoding circuit according to the present disclosure will be described in detail with reference to the following drawings.

FIG. 14 is a block diagram of a 0-th ECC decoding circuit of FIG. 11 according to an embodiment. Referring to FIGS. 11, 13, and 14, the 0-th ECC decoding circuit EDC0 may include a common arithmetic circuit 114b_1, a first syndrome comparison circuit 114b_2, and a second syndrome comparison circuit 114b_3. The common arithmetic circuit 114b_1 may generate a common arithmetic signal CAS based on the first comparison signal CS1. The common arithmetic circuit 114b_1 may be configured to perform the first to fifth comparison operations corresponding to the common regions R1 to R5 of FIG. 13.

In an embodiment, the first to fifth comparison operations may be referred to as a “common operation”.

The first syndrome comparison circuit 114b_2 may be configured to output the 0-th to fifth bits VEC0[0] to VEC0[5] and the twelfth to seventeenth bits VEC0[12] to VEC0[17] of the 0-th vector VEC0 based on the common arithmetic signal CAS and the second comparison signal CS2. The first syndrome comparison circuit 114b_2 may include the 0-th to fifth comparison circuits CMP0 to CMP5.

The 0-th comparison circuit CMP0 may be configured to compare the first column and the thirteenth column of the 0-th sub-matrix SM00 to output the 0-th bit VEC0[0] and the twelfth bit VEC0[12] of the 0-th vector VEC0. The first comparison circuit CMP1 may be configured to compare the second column and the fourteenth column of the 0-th sub-matrix SM00 to output the first bit VEC0[1] and the thirteenth bit VEC0[13] of the 0-th vector VEC0. The fifth comparison circuit CMP5 may be configured to compare the sixth column and the eighteenth column of the 0-th sub-matrix SM00 to output the fifth bit VEC0[5] and the seventeenth bit VEC0[17] of the 0-th vector VEC0.

The second syndrome comparison circuit 114b_3 may be configured to output the sixth to eleventh bits VEC0[6] to VEC0[11] and the eighteenth to twenty-third bits VEC0[18] to VEC0[23] of the 0-th vector VEC0 based on the common arithmetic signal CAS and the third comparison signal CS3. The second syndrome comparison circuit 114b_3 may include the sixth to eleventh comparison circuits CMP6 to CMP11.

The sixth comparison circuit CMP6 may be configured to compare the seventh column and the nineteenth column of the 0-th sub-matrix SM00 to output the sixth bit VEC0[6] and the eighteenth bit VEC0[18] of the 0-th vector VEC0. The seventh comparison circuit CMP7 may be configured to compare the eighth column and the twentieth column of the 0-th sub-matrix SM00 to output the seventh bit VEC0[7] and the nineteenth bit VEC0[19] of the 0-th vector VEC0. The eleventh comparison circuit CMP11 may be configured to compare the twelfth column and the twenty-fourth column of the 0-th sub-matrix SM00 to output the eleventh bit VEC0[11] and the twenty-third bit VEC0[23] of the 0-th vector VEC0.

In an embodiment, the syndrome comparison signal SCS of FIG. 11 may include the first to third comparison signals CS1 to CS3.

The first syndrome comparison circuit 114b_2 and the second syndrome comparison circuit 114b_3 may be configured to generate the 0-th vector VEC0 by using the common arithmetic signal CAS corresponding to the first to fifth common regions R1 to R5 of the 0-th sub-matrix SM00. That is, the first syndrome comparison circuit 114b_2 and the second syndrome comparison circuit 114b_3 may be configured to share the common arithmetic circuit 114b_1. Accordingly, the first syndrome comparison circuit 114b_2 and the second syndrome comparison circuit 114b_3 may omit decoding arithmetic circuits corresponding to the first to third common regions R1 to R5. Consequently, the area of the 0-th ECC decoding circuit EDC0 of FIG. 14 is smaller than the area of the 0-th ECC decoding circuit EDC0 of FIG. 12A.

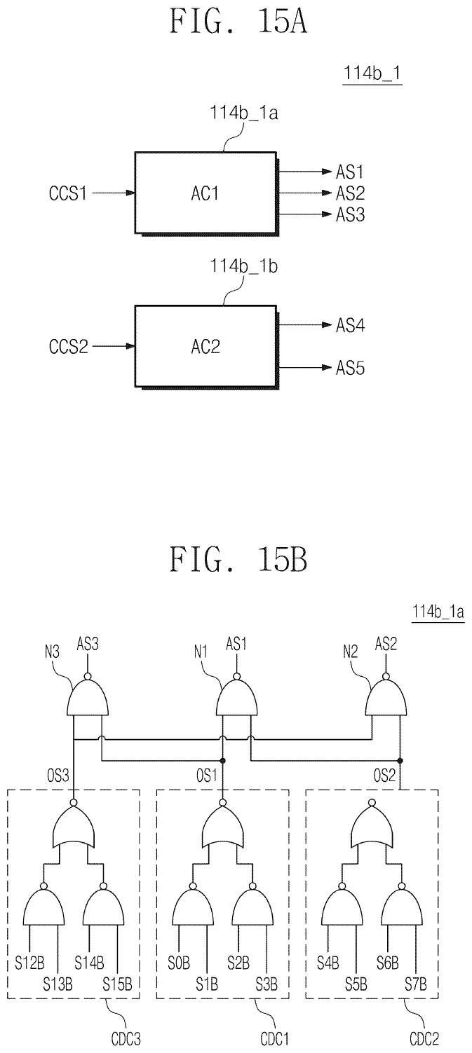

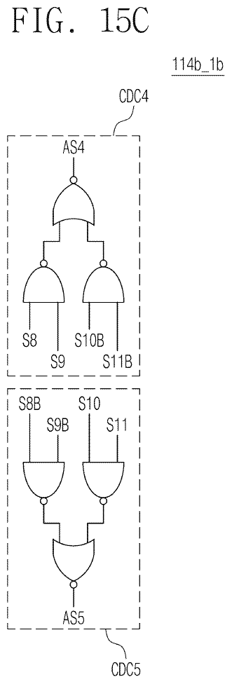

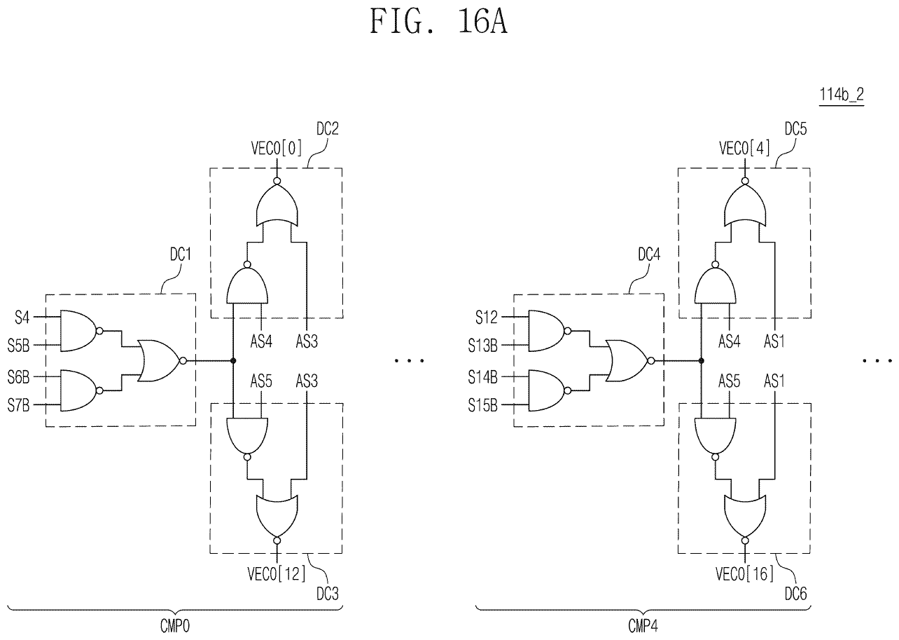

FIGS. 15A to 15C are diagrams for describing a common arithmetic circuit of FIG. 14 according to an example. Referring to FIGS. 13, 14, and 15A, the common arithmetic circuit 114b_1 may include a first arithmetic circuit 114b_1a and a second arithmetic circuit 114b_1b. The first arithmetic circuit 114b_1a may be configured to output first to third comparison arithmetic signals AS1 to AS3 by performing comparison operations for ECC decoding based on a first common comparison signal CCS1. In an embodiment, the first arithmetic circuit 114b_1a may be configured to perform the first to third comparison operations corresponding to the first to third common regions R1 to R3.

Referring to FIG. 15B, the first arithmetic circuit 114b_1a may include a first common decoding arithmetic circuit CDC1, a second common decoding arithmetic circuit CDC2, a third common decoding arithmetic circuit CDC3, and first to third NAND gates N1 to N3. Each of the first common decoding arithmetic circuit CDC1, the second common decoding arithmetic circuit CDC2, and the third common decoding arithmetic circuit CDC3 may be implemented with a 1-stage NAND arithmetic circuit and a 1-stage NOR arithmetic circuit.

The first common decoding arithmetic circuit CDC1 may be configured to receive the bits S0B, S1B, S2B, and S3B of the syndrome comparison signal SCS corresponding to the first common region R1 and to perform the first comparison operation. The first common decoding arithmetic circuit CDC1 may output a first output signal OS1 indicating a result of the first comparison operation.

The second common decoding arithmetic circuit CDC2 may be configured to receive the bits S4B, S5B, S6B, and S7B of the syndrome comparison signal SCS corresponding to the second common region R2 and to perform the second comparison operation. The second common decoding arithmetic circuit CDC2 may output a second output signal OS2 indicating a result of the second comparison operation.

The third common decoding arithmetic circuit CDC3 may be configured to receive the bits S12B, S13B, S14B, and S15B of the syndrome comparison signal SCS corresponding to the third common region R3 and to perform the third comparison operation. The third common decoding arithmetic circuit CDC3 may output a third output signal OS3 indicating a result of the third comparison operation.

The first NAND gate N1 may receive the first output signal OS1 and the second output signal OS2 as inputs and may output the first comparison arithmetic signal AS1. The first comparison arithmetic signal AS1 may indicate a result of comparing the bits S0 to S7 of the syndrome SYD with the first common region R1 and the second common region R2.

The second NAND gate N2 may receive the second output signal OS2 and the third output signal OS3 as inputs and may output the second comparison arithmetic signal AS2. The second comparison arithmetic signal AS2 may indicate a result of comparing the bits S4 to S7 and S12 to S15 of the syndrome SYD with the second common region R2 and the third common region R3.

The third NAND gate N3 may receive the first output signal OS1 and the third output signal OS3 as inputs and may output the third comparison arithmetic signal AS3. The third comparison arithmetic signal AS3 may indicate a result of comparing the bits S0 to S3 and S12 to S15 of the syndrome SYD with the first common region R1 and the third common region R3.

In an embodiment, the first common comparison signal CCS1 may be formed of the bits S0B, S1B, S2B, S3B, S4B, S5B, S6B, S7B, S12B, S13B, S14B, and S15B of the syndrome SYD for the first comparison operation to the third comparison operation.

Returning to FIG. 15A, the second arithmetic circuit 114b_1b may be configured to output fourth and fifth comparison arithmetic signals AS4 and AS5 by performing comparison operations for ECC decoding based on a second common comparison signal CCS2. In an embodiment, the second arithmetic circuit 114b_1b may be configured to perform the fourth and fifth comparison operations corresponding to the fourth and fifth common regions R4 and R5.

Referring to FIG. 15C, the second arithmetic circuit 114b_1b may include a fourth common decoding arithmetic circuit CDC4 and a fifth common decoding arithmetic circuit CDC5.

The fourth common decoding arithmetic circuit CDC4 may be configured to receive the bits S8, S9, S10B, and S11B of the syndrome comparison signal SCS corresponding to the fourth common region R4 and to perform the fourth comparison operation. The fourth common decoding arithmetic circuit CDC4 may output the fourth comparison arithmetic signal AS4 indicating a result of the fourth comparison operation.

In an embodiment, the fourth comparison arithmetic signal AS4 may indicate a result of comparing the bits S8 to S11 of the syndrome SYD with the fourth common region R4.

The fifth common decoding arithmetic circuit CDC5 may be configured to receive the bits S8B, S9B, S10, and S11 of the syndrome comparison signal SCS corresponding to the fifth common region R5 and to perform the fifth comparison operation. The fifth common decoding arithmetic circuit CDC5 may output the fifth comparison arithmetic signal AS5 indicating a result of the fifth comparison operation.

In an embodiment, the fifth comparison arithmetic signal AS5 may indicate a result of comparing the bits S8 to S11 of the syndrome SYD with the fifth common region R5.

In an embodiment, the second common comparison signal CCS2 may be formed of the bits S8, S9, S8B, S9B, S10, S11, S10B, and S11B of the syndrome SYD for the fourth comparison operation and the fifth comparison operation.

In an embodiment, the first comparison signal CS1 of FIG. 14 may include the first common comparison signal CCS1 and the second common comparison signal CCS2.

In an embodiment, the common arithmetic signal CAS of FIG. 14 may include the first to fifth comparison arithmetic signals AS1 to AS5.

As described above, the common arithmetic circuit 114b_1 may be configured to perform operations of comparing the syndrome SYD with common regions (e.g., R1 to R5) of a relevant sub-matrix (e.g., SM00) of the H-matrix H-mat.

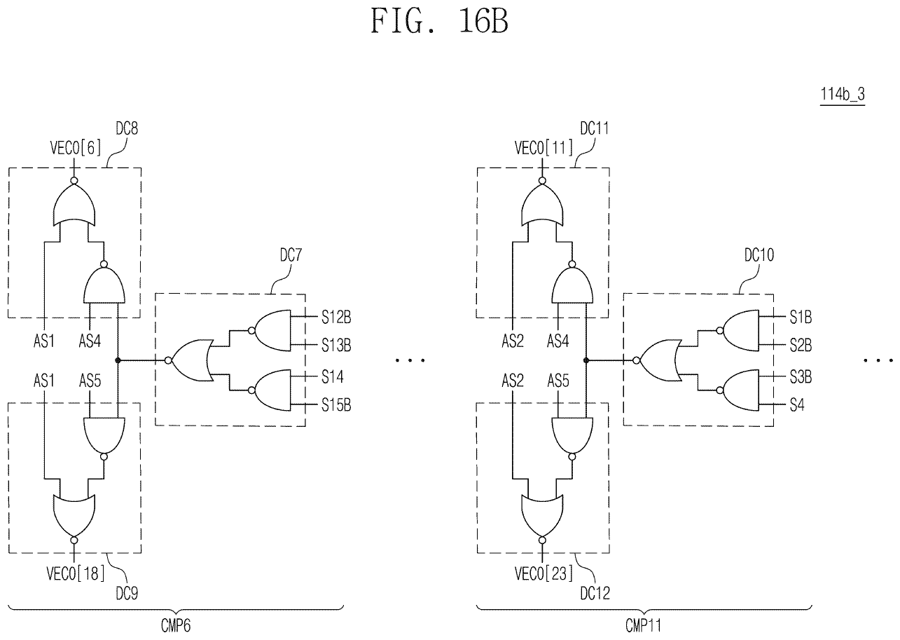

FIG. 16A is a diagram for describing a first syndrome comparison circuit of FIG. 14, and FIG. 16B is a diagram for describing a second syndrome comparison circuit of FIG. 14. Referring to FIGS. 14 to 16A, the first syndrome comparison circuit 114b_2 may include the 0-th comparison circuit CMP0 to the fourth comparison circuit CMP4. For convenience of description and for brevity of drawing, FIG. 16A only shows the 0-th comparison circuit CMP0 and the fourth comparison circuit CMP4, but the first comparison circuit CMP1, the second comparison circuit CMP2, the third comparison circuit CMP3, and the fifth comparison circuit CMP5 may be implemented to be similar to the 0-th comparison circuit CMP0 and the fourth comparison circuit CMP4.

The 0-th comparison circuit CMP0 may be configured to compare the syndrome SYD and the first column and the thirteenth column of the 0-th sub-matrix SM00 to output the 0-th bit VEC0[0] and the twelfth bit VEC0[12] of the 0-th vector VEC0. The 0-th comparison circuit CMP0 may include first to third decoding circuits DC1 to DC3 each implemented with a 1-stage NAND arithmetic circuit and a 1-stage NOR arithmetic circuit.

Elements (e.g., “1000”) at the fifth to eighth rows of the first column are the same as elements at the fifth to eighth rows of the thirteenth column of the 0-th sub-matrix SM00 (refer to FIG. 13). The first decoding arithmetic circuit DC1 may be configured to perform the comparison operation on elements (e.g., “1000”) at the fifth to eighth rows of the first column and the fifth to eighth rows of the thirteenth column and the bits S4 to S7 of the syndrome SYD. The first decoding arithmetic circuit DC1 may receive the bits S4, S5B, S6B, and S7B of the syndrome comparison signal SCS as inputs. An output signal of the first decoding arithmetic circuit DC1 may indicate a result of comparing the elements (e.g., “1000”) at the fifth to eighth rows of the first column and the fifth to eighth rows of the thirteenth column and the bits S4 to S7 of the syndrome SYD.

The second decoding arithmetic circuit DC2 may receive the output signal of the first decoding arithmetic circuit DC1, the third comparison arithmetic signal AS3, and the fourth comparison arithmetic signal AS4 as inputs and may output the 0-th bit VEC0[0] of the 0-th vector VEC0. That is, the NAND gate of the second decoding arithmetic circuit DC2 may be connected to an output terminal of the first decoding arithmetic circuit DC1 and an output terminal of the fourth common decoding arithmetic circuit CDC4 (refer to FIG. 15C). Also, the NOR gate of the second decoding arithmetic circuit DC2 may be connected to an output terminal of the third NAND gate N3 (refer to FIG. 15B).

The first to fourth rows belonging to the first column of the 0-th sub-matrix SM00 may be included in the first common region R1, and the thirteenth to sixteenth rows are included in the third common region R3. The ninth to twelfth rows belonging to the first column of the 0-th sub-matrix SM00 are included in the fourth common region R4 (refer to FIG. 13). As described above, the third comparison arithmetic signal AS3 corresponds to the first common region R1 and the third common region R3. Also, the fourth comparison arithmetic signal AS4 corresponds to the fourth common region R4.

Accordingly, the third comparison arithmetic signal AS3 may indicate a result of comparing the bits S0 to S3 and S12 to S15 of the syndrome SYD with the first to fourth rows and the thirteenth to sixteenth rows belonging to the first column of the 0-th sub-matrix SM00. Also, the fourth comparison arithmetic signal AS4 may indicate a result of comparing the bits S8 to S11 of the syndrome SYD with the ninth to twelfth rows belonging to the first column of the 0-th sub-matrix SM00. Accordingly, the 0-th bit VEC0[0] of the 0-th vector VEC0 may indicate a comparison result of the first column of the 0-th sub-matrix SM00 and the syndrome SYD.

The third decoding arithmetic circuit DC3 may receive the output signal of the first decoding arithmetic circuit DC1, the third comparison arithmetic signal AS3, and the fifth comparison arithmetic signal AS5 as inputs and may output the twelfth bit VEC0[12] of the 0-th vector VEC0. That is, the NAND gate of the third decoding arithmetic circuit DC3 may be connected to the output terminal of the first decoding arithmetic circuit DC1 and an output terminal of the fifth common decoding arithmetic circuit CDC5 (refer to FIG. 15C). Also, the NOR gate of the third decoding arithmetic circuit DC3 may be connected to the output terminal of the third NAND gate N3 (refer to FIG. 15B).

The first to fourth rows belonging to the thirteenth column of the 0-th sub-matrix SM00 may be included in the first common region R1, and the thirteenth to sixteenth rows are included in the third common region R3. The ninth to twelfth rows belonging to the thirteenth column of the 0-th sub-matrix SM00 are included in the fifth common region R5 (refer to FIG. 13).

Accordingly, the third comparison arithmetic signal AS3 may indicate a result of comparing the bits S0 to S3 and S12 to S15 of the syndrome SYD with the first to fourth rows and the thirteenth to sixteenth rows belonging to the thirteenth column of the 0-th sub-matrix SM00. Also, the fifth comparison arithmetic signal AS5 may indicate a result of comparing the bits S8 to S11 of the syndrome SYD with the ninth to twelfth rows belonging to the thirteenth column of the 0-th sub-matrix SM00. Accordingly, the twelfth bit VEC0[12] of the 0-th vector VEC0 may indicate a comparison result of the thirteenth column of the 0-th sub-matrix SM00 and the syndrome SYD.

The fourth comparison circuit CMP4 may be configured to compare the syndrome SYD and the fifth column and the seventeenth column of the 0-th sub-matrix SM00 to output the fourth bit VEC0[4] and the sixteenth bit VEC0[16] of the 0-th vector VEC0. The fourth comparison circuit CMP4 may include fourth to sixth decoding circuits DC4 to DC6 each implemented with a 1-stage NAND arithmetic circuit and a 1-stage NOR arithmetic circuit.

Elements (e.g., “1000”) at the thirteenth to sixteenth rows of the fifth column of the 0-th sub-matrix SM00 are the same as elements at the thirteenth to sixteenth rows of the seventeenth column of the 0-th sub-matrix SM00 (refer to FIG. 13). The fourth decoding arithmetic circuit DC4 may be configured to perform the comparison operation on elements (e.g., “1000”) at the thirteenth to sixteenth rows of the fifth column and the thirteenth to sixteenth rows of the seventeenth column and the bits S12 to S15 of the syndrome SYD. The fourth decoding arithmetic circuit DC4 may receive the bits S12, S13B, S14B, and S15B of the syndrome comparison signal SCS as inputs. An output signal of the fourth decoding arithmetic circuit DC4 may indicate a result of comparing the elements (e.g., “1000”) at the thirteenth to sixteenth rows of the fifth column and the thirteenth to sixteenth rows of the seventeenth column and the bits S12 to S15 of the syndrome SYD.

The first to fourth rows belonging to the fifth column and the seventeenth column of the 0-th sub-matrix SM00 may be included in the first common region R1, and the fifth to eighth rows are included in the second common region R2. The ninth to twelfth rows belonging to the fifth column of the 0-th sub-matrix SM00 are included in the fourth common region R4. The ninth to twelfth rows belonging to the seventeenth column of the 0-th sub-matrix SM00 are included in the fifth common region R5 (refer to FIG. 13).

Accordingly, the fifth decoding arithmetic circuit DC5 may receive an output signal of the fourth decoding arithmetic circuit DC4, the first comparison arithmetic signal AS1, and the fourth comparison arithmetic signal AS4 as inputs and may output the fourth bit VEC0[4] of the 0-th vector VEC0. That is, the NAND gate of the fifth decoding arithmetic circuit DC5 may be connected to an output terminal of the fourth decoding arithmetic circuit DC4 and the output terminal of the fourth common decoding arithmetic circuit CDC4 (refer to FIG. 15C). Also, the NOR gate of the fifth decoding arithmetic circuit DC5 may be connected to the output terminal of the first NAND gate N1 (refer to FIG. 15B).

As described above, the first comparison arithmetic signal AS1 corresponds to the first common region R1 and the second common region R2, and the fourth comparison arithmetic signal AS4 corresponds to the fourth common region R4. Accordingly, the fourth bit VEC0[4 ] of the 0-th vector VEC0 may indicate a comparison result of the fifth column of the 0-th sub-matrix SM00 and the syndrome SYD.

Also, the sixth decoding arithmetic circuit DC6 may receive the output signal of the fourth decoding arithmetic circuit DC4, the first comparison arithmetic signal AS1, and the fifth comparison arithmetic signal AS5 as inputs and may output the sixteenth bit VEC0[16] of the 0-th vector VEC0. That is, the NAND gate of the sixth decoding arithmetic circuit DC6 may be connected to the output terminal of the fourth decoding arithmetic circuit DC4 and the output terminal of the fifth common decoding arithmetic circuit CDC5 (refer to FIG. 15C). Also, the NOR gate of the sixth decoding arithmetic circuit DC6 may be connected to the output terminal of the first NAND gate N1 (refer to FIG. 15B).

As described above, the first comparison arithmetic signal AS1 corresponds to the first common region R1 and the second common region R2, and the fifth comparison arithmetic signal AS5 corresponds to the fifth common region R5. Accordingly, the sixteenth bit VEC0[16] of the 0-th vector VEC0 may indicate a comparison result of the seventeenth column of the 0-th sub-matrix SM00 and the syndrome SYD.

In an embodiment, the bits (e.g., S4, S5B, S6B, S7B, S12, S13B, S14B, and S15B) of the syndrome comparison signal SCS, which are input to the comparison circuits CMP0 to CMP4, may be included in the second comparison signal CS2 of FIG. 14.

Referring to FIGS. 14 to 16B, the second syndrome comparison circuit 114b_3 may include the sixth comparison circuit CMP6 to the eleventh comparison circuit CMP11. For convenience of description and for brevity of drawing, FIG. 16B only shows the sixth comparison circuit CMP6 and the eleventh comparison circuit CMP11, but the seventh comparison circuit CMP7, the eighth comparison circuit CMP8, the ninth comparison circuit CMP9, and the tenth comparison circuit CMP10 may be implemented to be similar to the sixth comparison circuit CMP6 and the eleventh comparison circuit CMP11.

The sixth comparison circuit CMP6 may be configured to compare the syndrome SYD and the seventh column and the nineteenth column of the 0-th sub-matrix SM00 to output the sixth bit VEC0[6] and the eighteenth bit VEC0[18] of the 0-th vector VEC0. The sixth comparison circuit CMP6 may include seventh to ninth decoding circuits DC7 to DC9 each implemented with a 1-stage NAND arithmetic circuit and a 1-stage NOR arithmetic circuit.

Elements (e.g., “0010) at the thirteenth to sixteenth rows of the seventh column of the 0-th sub-matrix SM00 are the same as elements at the thirteenth to sixteenth rows of the nineteenth column of the 0-th sub-matrix SM00. The first to fourth rows belonging to the seventh column of the 0-th sub-matrix SM00 and the first to fourth rows belonging to the nineteenth column of the 0-th sub-matrix SM00 may be included in the first common region R1, and the fifth to eighth rows may be included in the second common region R2. Also, the ninth to twelfth rows belonging to the seventh column of the 0-th sub-matrix SM00 may be included in the fourth common region R4, and the ninth to twelfth rows belonging to the nineteenth column are included in the fifth common region R5 (refer to FIG. 15).

Accordingly, the seventh decoding arithmetic circuit DC7 may be configured to receive the bits S12B, S13B, S14, and S15B of the syndrome comparison signal SCS corresponding to the thirteenth to sixteenth rows.

The eighth decoding arithmetic circuit DC8 may receive an output signal of the seventh decoding arithmetic circuit DC7, the first comparison arithmetic signal AS1 corresponding to the first common region R1 and the second common region R2, and the fourth comparison arithmetic signal AS4 corresponding to the fourth common region R4. The eighth decoding arithmetic circuit DC8 may output the sixth bit VEC0[6] of the 0-th vector VEC0 indicating a comparison result of the seventh column of the 0-th sub-matrix SM00 and the syndrome SYD. The NAND gate of the eighth decoding arithmetic circuit DC8 may be connected to an output terminal of the seventh decoding arithmetic circuit DC7 and an output terminal of the fourth common decoding arithmetic circuit CDC4 (refer to FIG. 15C). Also, the NOR gate of the eighth decoding arithmetic circuit DC8 may be connected to the output terminal of the first NAND gate N1 (refer to FIG. 15B).

The ninth decoding arithmetic circuit DC9 may receive the output signal of the seventh decoding arithmetic circuit DC7, the first comparison arithmetic signal AS1 corresponding to the first common region R1 and the second common region R2, and the fifth comparison arithmetic signal AS5 corresponding to the fifth common region R5. The ninth decoding arithmetic circuit DC9 may output the eighteenth bit VEC0[18] of the 0-th vector VEC0 indicating a comparison result of the nineteenth column of the 0-th sub-matrix SM00 and the syndrome SYD. The NAND gate of the ninth decoding arithmetic circuit DC9 may be connected to the output terminal of the seventh decoding arithmetic circuit DC7 and the output terminal of the fifth common decoding arithmetic circuit CDC5 (refer to FIG. 15C). Also, the NOR gate of the ninth decoding arithmetic circuit DC9 may be connected to the output terminal of the first NAND gate N1 (refer to FIG. 15B).

The eleventh comparison circuit CMP11 may be configured to compare the syndrome SYD and the twelfth column and the twenty-fourth column of the 0-th sub-matrix SM00 to output the eleventh bit VEC0[11] and the twenty-third bit VEC0[23] of the 0-th vector VEC0. The eleventh comparison circuit CMP11 may include tenth to twelfth decoding circuits DC10 to DC12 each implemented with a 1-stage NAND arithmetic circuit and a 1-stage NOR arithmetic circuit.

Meanwhile, elements (e.g., “0001) at the first to fourth rows of the twelfth column of the 0-th sub-matrix SM00 are the same as elements at the first to fourth rows of the twenty-fourth column of the 0-th sub-matrix SM00. The fifth to eighth rows belonging to the twelfth column of the 0-th sub-matrix SM00 and the fifth to eighth rows belonging to the twenty-fourth column of the 0-th sub-matrix SM00 may be included in the second common region R2, and the thirteenth to sixteenth rows may be included in the third common region R3. Also, the ninth to twelfth rows belonging to the twelfth column of the 0-th sub-matrix SM00 may be included in the fourth common region R4, and the ninth to twelfth rows belonging to the twenty-fourth column are included in the fifth common region R5 (refer to FIG. 13).

Accordingly, the tenth decoding arithmetic circuit DC10 may be configured to receive the bits S1B, S2B, S3B, and S4 of the syndrome comparison signal SCS corresponding to the first to fourth rows belonging to each of the twelfth and twenty-fourth columns of the 0-th sub-matrix SM00. The tenth decoding arithmetic circuit DC10 may perform an operation of performing the 0-th to third bits S0 to S3 of the syndrome SYD and the first to fourth rows belonging to each of the twelfth and twenty-fourth columns of the 0-th sub-matrix SM00.

The eleventh decoding arithmetic circuit DC11 may receive an output signal of the tenth decoding arithmetic circuit DC10, the second comparison arithmetic signal AS2 corresponding to the second common region R2 and the third common region R3, and the fourth comparison arithmetic signal AS4 corresponding to the fourth common region R4. The eleventh decoding arithmetic circuit DC11 may configured to output the eleventh bit VEC0[11] of the 0-th vector VEC0 indicating a comparison result of the twelfth column of the 0-th sub-matrix SM00 and the syndrome SYD. The NAND gate of the eleventh decoding arithmetic circuit DC11 may be connected to an output terminal of the tenth decoding arithmetic circuit DC10 and the output terminal of the fourth common decoding arithmetic circuit CDC4 (refer to FIG. 15C). Also, the NOR gate of the eleventh decoding arithmetic circuit DC11 may be connected to an output terminal of the second NAND gate N2 (refer to FIG. 15B).

The twelfth decoding arithmetic circuit DC12 may receive the output signal of the tenth decoding arithmetic circuit DC10, the second comparison arithmetic signal AS2 corresponding to the second common region R2 and the third common region R3, and the fifth comparison arithmetic signal AS5 corresponding to the fifth common region R5. The twelfth decoding arithmetic circuit DC12 may output the twenty-third bit VEC0[23] of the 0-th vector VEC0 indicating a comparison result of the nineteenth column of the 0-th sub-matrix SM00 and the syndrome SYD. The NAND gate of the twelfth decoding arithmetic circuit DC12 may be connected to the output terminal of the tenth decoding arithmetic circuit DC10 and the output terminal of the fifth common decoding arithmetic circuit CDC5 (refer to FIG. 15C). Also, the NOR gate of the twelfth decoding arithmetic circuit DC12 may be connected to the output terminal of the second NAND gate N2 (refer to FIG. 15B).

In an embodiment, the bits (e.g., S1B, S2B, S3B, S4, S12B, S13B, S14, and S15B) of the syndrome comparison signal SCS, which are input to the comparison circuits CMP6 to CMP11, may be included in the third comparison signal CS3 of FIG. 14.

As described above, the comparison circuits CMP0 to CMP11 may be configured to “share the common arithmetic circuit 114b_1” by operating based on a shared output signal CAS of the common arithmetic circuit 114b-1. In detail, the comparison circuits CMP0 to CMP11 may be connected to at least some of the output terminals of the common arithmetic circuit 114b_1 (e.g., the output terminals of the first to third NAND gates N1 to N3, the output terminal of the fourth common decoding arithmetic circuit CDC4, and the output terminal of the fifth common decoding arithmetic circuit CDC5). The comparison circuits CMP0 to CMP11 may compare the syndrome SYD and each column of the sub-matrix SM00 of the H-matrix H-mat by using the common arithmetic signal CAS output from the common arithmetic circuit 114b_1. Accordingly, unlike the example of FIG. 12A, the comparison circuits CMP0 to CMP6 may omit identical decoding circuits (e.g., DC1, DC2, and DC4 of FIG. 12A) in duplicate. Accordingly, the area of the ECC decoding circuits EDC0 to EDC11 may be reduced.

Only the 0-th ECC decoding circuit EDC0 of FIG. 11 is described with reference to FIGS. 14 to 16B, but the first to eleventh ECC decoding circuits EDC1 to EDC11 of FIG. 11 may also be implemented to be similar to the 0-th ECC decoding circuit EDC0. That is, each of the first to eleventh ECC decoding circuits EDC1 to EDC11 may include a common arithmetic circuit which performs an operation on the common regions of the corresponding sub-matrices SM00 to SM11 and PR of the H-matrix H-mat.

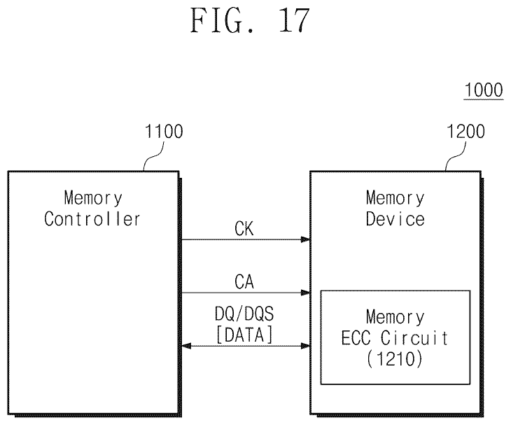

FIG. 17 is a block diagram illustrating a memory system according to an embodiment of the present disclosure. Referring to FIG. 17, a memory system 1000 may include a memory controller 1100 and a memory device 1200.

The memory device 1200 may operate under control of the memory controller 1100. The memory device 1200 may include an ECC circuit 1210. The ECC circuit 1210 may be configured to detect and correct an error of data present in the memory device 1200. The ECC circuit 1210 may generate parity check data based on the read data present in the memory device 1200. The ECC circuit 1210 may generate a syndrome based on the parity check data and the read parity data corresponding to the read data and generate an error vector by comparing the H-matrix H-mat and the syndrome. The ECC circuit 1210 may correct an error of the read data and the read parity data based on the read data, the read parity data, and the error vector.

In an embodiment, the ECC circuit 1210 may be implemented to be the same as the ECC circuit (e.g., the memory ECC circuit 110 of FIG. 3) described with reference to FIGS. 1 to 16B. That is, the ECC circuit 1210 may be configured to generate the parity check data by performing the XOR operation only on effective elements of the H-matrix H-mat. Also, the ECC circuit 1210 may include a common arithmetic circuit which outputs a common arithmetic signal by performing operations corresponding to the common regions of the H-matrix H-mat. The ECC circuit 1210 may be configured to generate an error vector based on the common arithmetic signal.

According to the present disclosure, an ECC circuit included in a memory device may include a common (i.e., shared) arithmetic circuit. The common arithmetic circuit may perform an operation on common regions among a plurality of regions of the H-matrix and may output a common arithmetic signal. The ECC circuit may perform ECC decoding based on the common arithmetic signal. Accordingly, the ECC circuit may omit unnecessary arithmetic circuits. Consequently, the area which the ECC circuit occupies in the memory device may be reduced. Accordingly, an error correction code circuit having a smaller size relative to prior art ECC circuits, a memory device including the error correction code circuit, and a memory system including the memory device are provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A memory device comprising:
an input/output circuit configured to receive first data and parity data from a memory controller;
an error correction code (ECC) encoder configured to generate parity check data based on the first data;
a syndrome generator circuit configured to generate a syndrome based on the parity check data and the parity data;
an error vector generator configured to perform ECC decoding based on the syndrome and to generate an error vector;
an error correction circuit configured to generate error-corrected data based on the error vector, the first data, and the parity data; and
a memory cell array configured to store the error-corrected data,
wherein the error vector generator includes:
an arithmetic circuit configured to perform a common operation associated with the ECC decoding based on the syndrome and to generate a common arithmetic signal; and
a plurality of comparison circuits configured to generate the error vector based on the syndrome and the common arithmetic signal.

2. The memory device of claim 1, wherein the ECC encoder is further configured to generate the parity check data based on a parity-check matrix, and
wherein the error vector generator is further configured to generate the error vector based on the parity-check matrix.

3. The memory device of claim 2, wherein the ECC encoder includes:
a plurality of encoding circuits configured to generate a plurality of check data based on the first data; and
an XOR circuit configured to generate the parity check data based on the plurality of check data.

4. The memory device of claim 3, wherein a first encoding circuit among the plurality of encoding circuits is configured to perform ECC encoding corresponding to a first sub-matrix among a plurality of sub-matrices included in the parity-check matrix based on first sub-data included in the first data such that first check data among a plurality of check data are output.

5. The memory device of claim 4, wherein the first encoding circuit includes:
an XOR gate configured to receive a first bit and a second bit among bits of the first sub-data and to output a first check bit among bits of the first check data.

6. The memory device of claim 2, wherein the arithmetic circuit includes:
a first arithmetic circuit configured to output a first comparison arithmetic signal to a third comparison arithmetic signal corresponding to a first common region to a third common region among a plurality of common regions included in the parity-check matrix; and
a second arithmetic circuit configured to output a fourth comparison arithmetic signal and a fifth comparison arithmetic signal corresponding to a fourth common region and a fifth common region among the plurality of common regions, and
wherein the common arithmetic signal includes the first comparison arithmetic signal to the fifth comparison arithmetic signal.

7. The memory device of claim 6, wherein the first arithmetic circuit includes:
a first common decoding arithmetic circuit configured to perform a first comparison operation corresponding to the first common region to output a first output signal;
a second common decoding arithmetic circuit configured to perform a second comparison operation corresponding to the second common region to output a second output signal; and
a third common decoding arithmetic circuit configured to perform a third comparison operation corresponding to the third common region to output a third output signal.

8. The memory device of claim 7, wherein the first arithmetic circuit further includes:
a first NAND gate configured to output the first comparison arithmetic signal corresponding to the first common region and the second common region based on the first output signal and the second output signal;
a second NAND gate configured to output the second comparison arithmetic signal corresponding to the second common region and the third common region based on the second output signal and the third output signal; and
a third NAND gate configured to output the third comparison arithmetic signal corresponding to the first common region and the third common region based on the first output signal and the third output signal.

9. The memory device of claim 8, wherein the second arithmetic circuit includes:
a fourth common decoding arithmetic circuit configured to perform a fourth comparison operation corresponding to the fourth common region to output the fourth comparison arithmetic signal; and
a fifth common decoding arithmetic circuit configured to perform a fifth comparison operation corresponding to the fifth common region to output the fifth comparison operation signal.

10. The memory device of claim 8, wherein the plurality of comparison circuits include a first comparison circuit and a second comparison circuit,
wherein the first comparison circuit is configured to:
output a first error bit based on the syndrome, the third comparison arithmetic signal, and the fourth comparison arithmetic signal; and
output a second error bit based on the syndrome, the third comparison arithmetic signal, and the fifth comparison arithmetic signal, and
wherein the error vector includes the first error bit and the second error bit.

11. The memory device of claim 2, wherein the error vector generator generates the error vector by comparing the syndrome with each column of the parity-check matrix.

12. The memory device of claim 1, further comprising:
a command and address buffer configured to receive and buffer command/address signals (CA) from the memory controller;
an address decoder configured to receive an address signal from the command and address buffer and to decode the address signal;
a command decoder configured to receive a command signal from the command and address buffer and to decode the command signal;
a row decoder configured to control a plurality of word lines connected to the memory cell array depending on an address decoding result of the address decoder;
a column decoder configured to control a plurality of bit lines connected with the memory cell array depending on the address decoding result of the address decoder; and
a write driver configured to store the error-corrected data in the memory cell array under control of the command decoder.

13. An error correction code (ECC) circuit which is configured to generate error-corrected data based on first data and parity data received from a memory controller, comprising:
an ECC encoder configured to generate parity check data based on the first data; and
an ECC decoder configured to perform ECC decoding based on the first data, the parity data, and the parity check data and to output the error-corrected data,
wherein the ECC decoder includes:
a syndrome generator circuit configured to generate a syndrome based on the parity check data and the parity data;
an error vector generator configured to decode the syndrome to generate an error vector; and
an error correction circuit configured to generate the error-corrected data based on the error vector, the first data, and the parity data, and
wherein the error vector generator includes:
an arithmetic circuit configured to perform a common operation associated with the ECC decoding based on the syndrome and to generate a common arithmetic signal; and
a plurality of comparison circuits configured to generate the error vector based on the syndrome and the common arithmetic signal.

14. The ECC circuit of claim 13, wherein the ECC encoder is further configured to generate the parity check data based on a parity-check matrix, and
wherein the error vector generator is further configured to generate the error vector based on the parity-check matrix.

15. The ECC circuit of claim 13, wherein the ECC encoder includes:
a plurality of encoding circuits configured to generate a plurality of check data based on the first data; and
an XOR circuit configured to generate the parity check data based on the plurality of check data.

16. The ECC circuit of claim 15, wherein a first encoding circuit among the plurality of encoding circuits is configured to perform an encoding operation corresponding to a first sub-matrix among a plurality of sub-matrices included in a parity-check matrix based on first sub-data included in the first data such that first check data among the plurality of check data are output and includes an XOR gate configured to receive a first bit and a second bit among bits of the first sub-data and to output a first check bit among bits of the first check data.

17. The ECC circuit of claim 14, wherein the arithmetic circuit includes:
a first arithmetic circuit configured to output a first comparison arithmetic signal to a third comparison arithmetic signal corresponding to a first common region to a third common region among a plurality of common regions included in the parity-check matrix; and
a second arithmetic circuit configured to output a fourth comparison arithmetic signal and a fifth comparison arithmetic signal corresponding to a fourth common region and a fifth common region among the plurality of common regions, and
wherein the common arithmetic signal includes the first to fifth comparison arithmetic signals.

18. The ECC circuit of claim 17, wherein the first arithmetic circuit includes:
a first common decoding arithmetic circuit configured to perform a first comparison operation corresponding to the first common region to output a first output signal;
a second common decoding arithmetic circuit configured to perform a second comparison operation corresponding to the second common region to output a second output signal; and
a third common decoding arithmetic circuit configured to perform a third comparison operation corresponding to the third common region to output a third output signal.

19. The ECC circuit of claim 18, wherein the first arithmetic circuit further includes:
a first NAND gate configured to output the first comparison arithmetic signal corresponding to the first common region and the second common region based on the first output signal and the second output signal;
a second NAND gate configured to output the second comparison arithmetic signal corresponding to the second common region and the third common region based on the second output signal and the third output signal; and
a third NAND gate configured to output the third comparison arithmetic signal corresponding to the first common region and the third common region based on the first output signal and the third output signal.

20. A memory system comprising:
a memory controller configured to output first data and parity data generated based on the first data; and
a memory device including an error correction code (ECC) circuit configured to receive the first data and the parity data, generate error-corrected data based on the first data and the parity data, and store the error-corrected data,
wherein the ECC circuit includes:
an ECC encoder configured to generate parity check data based on the first data;
a syndrome generator configured to generate a syndrome based on the parity check data and the parity data;
an error vector generator configured to generate an error vector by ECC decoding the syndrome; and
an error correction circuit configured to generate the error-corrected data based on the error vector, the first data, and the parity data, and
wherein the error vector generator includes:
an arithmetic circuit configured to perform a common operation associated with the ECC decoding based on the syndrome and to generate a common arithmetic signal; and
a plurality of comparison circuits configured to generate the error vector based on the syndrome and the common arithmetic signal.
